(19) United States
(12) Patent Application Publication
(10) Pub. No.: US 2024/0428261 A1
(43) Pub. Date: Dec. 26, 2024

(54) DELINEATING PARCELS OF LAND ON A GRAPHICAL USER INTERFACE

(71) Applicant: Inventus Holdings, LLC, Juno Beach, FL (US)

(72) Inventors: Keith J. HARDING, Minneapolis, MN (US); Alexander A.D. KIRSCH, Mineapolis, MN (US); Ian J. FISKE, Jacksonville, FL (US); Richard WALKER, JR., Lakeville, MN (US); Sriharsha VEERAMACHANENI, Minneapolis, MN (US)

(21) Appl. No.: 18/339,357

(22) Filed: Jun. 22, 2023

Related U.S. Application Data
(63) Continuation-in-part of application No. 17/930,764, filed on Sep. 9, 2022.

(51) Int. Cl. G06Q 30/018

(52) U.S. Cl. CPC G06Q 30/018

(57) ABSTRACT

Disclosed is a system and method for identifying various combinations of parcels of land with sufficient transmission, resources, market demand, and available land to build a construct a green hydrogen facility, synthetic natural gas facility and/or an ammonia production facility. Different criteria associated with each parcel of land include land characteristics, including size, ownership, transportation networks, power and water network prices, factories/plants, wells, and community-specific information, market characteristics including historical locational marginal pricing (LMPs). In one example, the present invention identifies clusters of land parcels that minimize the number of land owners, maximize buildable land, minimize transmission cost, maximize NCF, and maximize nodal LMPs.

### CROSS-REFERENCE TO RELATED APPLICATIONS

This application claims priority from and is related to U.S. application Ser. No. 17/930,764, entitled “Identification Of Renewable Energy Site” with attorney docket number 098149/480-P0132, filed Sep. 9, 2022, which is hereby incorporated into the present application by reference in its entirety.

### FIELD OF THE DISCLOSURE

The present invention generally relates to interactive graphical overlays on a map in response to analyzing parcels of land for the development of renewable energy projects, namely wind farms, solar farms, energy storage, green hydrogen facility, synthetic natural gas facility, and ammonia production facility and, more particularly, relates to identifying individual parcels of land, when aggregated, meet the goals for the development of renewable energy projects.

### BACKGROUND

According to the U.S. Department of Energy, more wind energy was installed in the year 2020 than any other energy source, accounting for 42% of new U.S. capacity. In addition, utility-scale solar farm value is projected to quadruple by the year 2027.

Developing utility-scale renewable energy farms take time. There are two distinct phases the development phase and the construction phase. Together they typically take six or more years to complete. The development stage currently takes about two-thirds of this six-year time period. The development stage includes planning and site acquisition, transmission studies and interconnect agreement with the utility, negotiation of the power purchase agreement with a prospective off taker, transmission permitting, generating permitting and approval, and financing. The construction phase includes the construction of transmission upgrades and site improvement, plant construction, and testing.

To produce renewable energy projects for specific utility-scale generation capacity, typically in Megawatts (MW), parcels of land must review. Identifying the best renewable energy sites across a large geographical area (e.g., the United States) is difficult because many factors, including resource considerations, land considerations, transmission considerations, and market considerations, may render any site uneconomic.

Historically, the development phase planning activities have been manually intensive. In order to determine the final development timeline, a planner models various scenarios in a spreadsheet to ensure operational constraints are respected. At the end of the planning process, there is no way to determine if the final schedule is optimal because of a very large number of combinatorial factors are not solvable by a team of humans with a spreadsheet.

### SUMMARY OF THE INVENTION

The present invention provides a novel method and system for delineating parcels of land on an interactive graphical user interface of a computer system that identifies parcels of land to construct a green hydrogen facility, synthetic natural gas facility or an ammonia production facility. The method includes performing a plurality of project projections. The projections include accessing data from various sources related to green hydrogen, synthetic natural gas, and ammonia production, including one or more of land parcels, transportation networks, power and water network prices, factories/plants, wells, and community-specific information, or a combination thereof. Next, the projections include converting the data accessed into a uniform data format for each source. The projections also include filtering out data accessed to remove unviable parcels based on one or more of installed wind turbines or solar panels, proposed wind or solar plants, a percentage load served by renewables, designated protected areas, small land parcels, or a combination thereof. Next, a score is assigned to inputs that have been converted to a uniform format and filtered to remove unviable land parcels.

A total number of simulations (M) are executed simultaneously in parallel over each of a plurality of electrolyzer capacities. The simulations (M) include evaluating each of a plurality of parcels of land in a portfolio based on scoring; and executing a clustering algorithm to produce results, wherein the results include a sub-set of the plurality of parcels of land in the portfolio.

Next, the results are ranked from the total number of scoring simulations (M) with the highest combined score for clustered parcels of land in the portfolio based on a combination of input costs, transport access, market demand, and land characteristics for a given fuel such as hydrogen, ammonia, or synthetic natural gas.

The results are sent to an interactive display allowing users to visualize the results of ranking and clustering for a user-selected electrolyzer capacity and fuel type.

### BRIEF DESCRIPTION OF THE DRAWINGS

The accompanying figures, where like reference numerals, refer to identical or functionally similar elements throughout the separate views, and which, together with the detailed description below, are incorporated in and form part of the specification, serve to further illustrate various embodiments and to explain various principles and advantages all in accordance with the present disclosure, in which:

FIG. 1 illustrates a combination of renewable energy sources, specifically wind, solar, and battery, on a parcel of land, according to the prior art;

FIG. 2 illustrates large areas of renewable energy sources using solar across many acres and parcels of land that form a non-rectangular shape, according to the prior art;

FIG. 3 is a pictorial overview of the process of scoring resource characteristics, transmission characteristics, land characteristics, and market demand characteristics for a portfolio of a plurality of land parcels with filtering, clustering, ranking, and presenting, according to an example of the present invention;

FIG. 4 is a pictorial view of 386 different multi-county regions in the continental USA based on ReEDs capacity, according to an example of the present invention;

FIG. 5 is a cluster in Oklahoma (note that the top three owners appear to be the same but are structured differently, according to an example of the present invention;

FIG. 6 is a graph of transmission costs versus transmission scores, according to an example of the present invention;

FIG. 7A is a pictorial map of color-code land score values with various filters for a 150 MW wind farm and FIG. 7B is as FIG. 7A but for the overall score, according to an example of the present invention;

FIG. 8 is a graph of parcel size score versus land owner's parcel size, according to an example of the present invention:

FIG. 9 is a graph of owner count score versus the number of owners for solar and wind, according to an example of the present invention;

FIG. 10 is a graph of the buildable area score versus the percentage of buildable land in a search radius, according to an example of the present invention;

FIG. 11 is a graph of the land value score versus parcel value, according to an example of the present invention;

FIG. 12 is a series of pictorial diagrams representing parcel sentiment score, parcel sentiment score boost, land parcel clusters, and cluster sentiment score boost, according to an example of the present invention;

FIG. 13 is a graph of sentiment score adder versus unadjusted score based on the type of land listing, according to an example of the present invention;

FIG. 14A and FIG. 14B are pictorial maps of color-code sentiment boost score values with various filters, according to an example of the present invention:

FIG. 15 is an example user interface that illustrates a pictorial map of color-code of solar prospect recommended by the system with buildable land highlighted, according to an example of the present invention:

FIG. 16 is an example user interface that illustrates a pictorial map of color-code of wind clusters recommended wind cluster of land parcels, including overall score characteristics, plus resource characteristics, land characteristics, transmission characteristics, and other sub-scores, according to an example of the present invention;

FIG. 17 is an example user interface that illustrates a pictorial map of color-code of wind clusters recommended wind cluster of land parcels, including overall score characteristics, plus scores for resource characteristics, land characteristics, and transmission characteristics, as well as land owner sentiment, according to an example of the present invention;

FIG. 18 is a flow method for identifying parcels of land to construct a renewable energy generation facility to generate electricity, according to an example of the present invention;

FIG. 19 illustrates types of hydrogen generation and uses in power generation, transportation, and industry, according to the prior art;

FIG. 20 illustrates a high-level view of two new tools i) H2Viewer and ii) HDOT, to provide a prospecting and optimization approach for green hydrogen, according to an example of the present invention;

FIG. 21 illustrates a high-level view of the new H2Viewer tool, according to an example of the present invention;

FIG. 22 illustrates a high-level view of the new H2Viewer tool prospecting algorithm, according to an example of the present invention;

FIG. 23 illustrates a high-level view of the inputs used with the new H2Viewer tool, according to an example of the present invention;

FIG. 24 illustrates an example of three clustering outputs of the H2Viewer tool, according to an example of the present invention;

FIG. 25 is an example graph of wind cost per MW and solar cost per MW based on plant size, according to an example of the present invention;

FIG. 26 is an example graph of electricity cost for fixed costs versus variable costs for solar, according to an example of the present invention;

FIG. 27 is an example graph of electricity cost for fixed costs versus variable costs for wind, according to an example of the present invention;

FIG. 28A thru FIG. 28D is a table of input cost data, according to an example of the present invention;

FIG. 29 is a graph of oil/gas pipeline score by distance, according to an example of the present invention;

FIG. 30 is an illustration of a map with the oil/gas pipeline score applied with abandoned ammonia pipeline included, such as those of FIG. 29, to identify a combination of parcels of land with the highest score or ranking, according to an example of the present invention;

FIG. 31 is an illustration of a map with the 100 MW transport score applied without the abandoned ammonia pipeline included to identify a combination of parcels of land with the highest score or ranking, according to an example of the present invention;

FIG. 32 is an illustration of a map with the 100 MW transport score applied with the abandoned ammonia pipeline included to identify a combination of parcels of land with the highest score or ranking, according to an example of the present invention;

FIG. 33 is an illustration of an interstate highway distance versus transportation score using color emphasis by distance, according to an example of the present invention;

FIG. 34 is an illustration of a map with Texas transport scores applied using 100 MW electrolyzer, to identify a combination of parcels of land with the highest score or ranking, according to an example of the present invention;

FIG. 35 is a table of various green hydrogen transmission routing categories, according to an example of the present invention;

FIG. 36 is an example of clustering parcels of land to provide a prospect score for 100 MW electrolyzer, according to an example of the present invention;

FIG. 37 is a table of various simplified considerations for prospects, according to an example of the present invention;

FIG. 38 is a table of various more advanced considerations for prospects, according to an example of the present invention;

FIG. 39A and FIG. 39B is an illustration of a map with a ranking of landowners for a 100 MW Green Hydrogen project, to identify a combination of parcels of land with the highest score or ranking, according to an example of the present invention;

FIG. 40A and FIG. 40B is a map with a ranking of landowners for a 100 MW Green Hydrogen project to identify a combination of parcels of land with the highest score or ranking, along with displaying hydrogen pipelines, ammonia pipelines, oil & gas pipelines, transmission lists, substations, and wind projects, according to an example of the present invention;

FIG. 41A and FIG. 41B is a map with score information after a user selection of Name 111 in FIG. 40, according to an example of the present invention;

FIG. 42A and FIG. 42B is a map with cluster information after a user selection of the cluster in FIG. 41, according to an example of the present invention;

FIG. 43 is a graph of customer score by customer distance, according to an example of the present invention;

FIG. 44A and FIG. 44B is an illustration of a map with a layering of information based on user selection for hydrogen, according to an example of the present invention;

FIG. 45A and FIG. 45B is a table of data used for maps, according to an example of the present invention;

FIG. 46 is a flow method for identifying parcels of land to construct a green hydrogen, synthetic natural gas, or an ammonia production facility, according to an example of the present invention; and

FIG. 47 illustrates a block diagram illustrating a processing system for carrying out portions of the present invention.

### DETAILED DESCRIPTION

As required, detailed embodiments are disclosed herein; however, it is to be understood that the disclosed embodiments are merely examples and that the systems and methods described below are embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

### Non-Limiting Definitions

Generally, the terms “a” or “an”, as used herein, are defined as one or more than one. The term plurality, as used herein, is defined as two or more than two.

The term “adapted to” describes the hardware, software, or a combination of hardware and software that is capable of, able to accommodate, to make, or that is suitable to carry out a given function.

The term “another”, as used herein, is defined as at least a second or more.

The term “configured to” describes the hardware, software or a combination of hardware and software that is adapted to, set up, arranged, built, composed, constructed, designed, or that has any combination of these characteristics to carry out a given function.

The term “coupled,” as used herein, is defined as “connected,” although not necessarily directly, and not necessarily mechanically.

The term “fatal flaw” or “low score escalators” means that one of the land characteristics for a given parcel of land makes it entirely undesirable for development, even if the other land characteristics score high. For example, if the land owner is listed as a U.S. National Park, this parcel of land, in general, is not feasible for development.

The term “independent system operator” or “ISO” is an organization formed at the recommendation of the Federal Energy Regulatory Commission. In the areas where an ISO is established, it coordinates, controls, and monitors the operation of the electrical power system, usually within a single U.S. state but sometimes encompassing multiple states. Regional Transmission Organizations (RTOs) typically perform the same functions as ISOs but cover a larger geographic area.

The terms “including” and “having,” as used herein, are defined as comprising (i.e., open language).

The term “land characteristics” includes size, ownership, tree coverage, elevations, terrain, buildable land, location of nearby renewable projects, and the owner's willingness or sentiment to sell rights.

The term “locational marginal pricing” or “LMP” is adapting wholesale electric energy prices to reflect the value of electric energy at different locations, accounting for the patterns of load, generation, and the physical limits of the transmission system.

The term “NEE” is abbreviation for NextEra Energy and “NEER” is an abbreviation for NextEra Energy Resources, a subsidiary of NEE.

The term “net capacity factor” or “NCF” is the ratio of actual electrical energy output over a given period of time divided by the theoretical continuous maximum electrical energy output over that period.

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The term “resource characteristics” includes the net capacity factor (NCF) of wind or solar, which describes the fraction of total capacity that is produced over the course of a typical year. Typical total capacities include 20, 25, 50, 75, 100, 150, 200, 250, 400 Megawatts. Note solar capacities are typically on the lower end, and wind capacities are typically on the higher end of these typical capacities.

The term “simultaneous” means computations are carried out at the same time, which for larger data sets with various constraints is not possible to be carried out completed by a group of humans and must be performed by a computer. For example, one human could not compute one simulation with all the constraints for thousands of various clusters of parcels of land across multiple counties and across multiple states with all the various criteria. It is infeasible for a human to calculate one simulation loop with one constraint, let alone perform it in parallel to a sort of global optimum.

The term “transmission characteristics” includes substation hardware costs, network upgrades, and grid tie-in costs, such as those to be compatible with Federal Energy Regulatory Commission Order 845.

The term “uniform data format” means data in a given format, whether date format, time format, currency format, scientific format, text format, or fractional format, so that all values of data are presented in a single consistent format for a given category or criteria.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

Although the elements in the following method claims, if any, are recited in a particular sequence with corresponding labeling unless the claim recitations otherwise imply a particular sequence for implementing some or all of those elements, those elements are not necessarily intended to be limited to being implemented in that particular sequence.

### Overview for Solar, Wind, and Storage Utility Scale Renewable Energy Sites-Embodiment

Disclosed is a system for identifying a broad range of utility-scale renewable energy sites that are likely to be profitable and successful, across the whole country, based on a ranking algorithm that is displayed within a user interface (UI). The system provides developers with actionable information that increases the likelihood of project success while reducing the time to conclude recommended clusters of land parcels and a streamlined user interface that provides information not readily available.

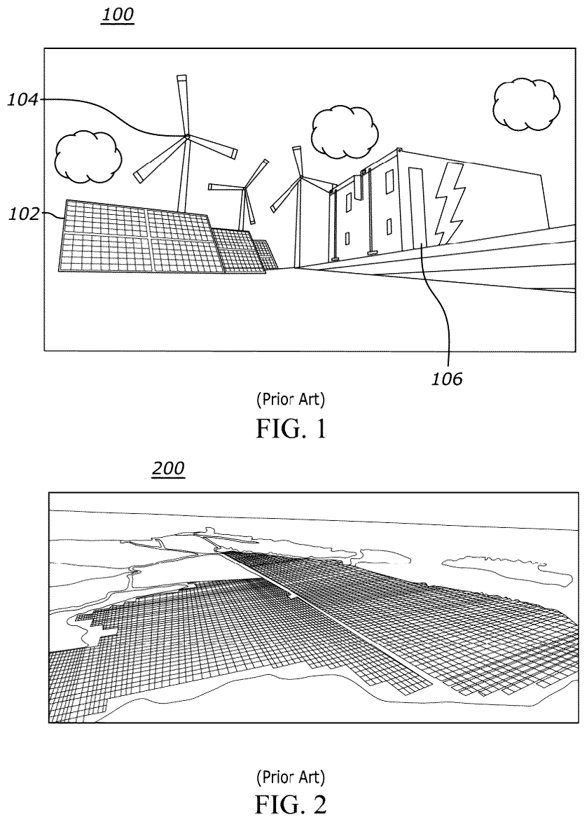

Turning to FIG. 1, shown is a combination of renewable energy sources 100. More specifically, shown is solar arrays 102, wind turbines 104, and battery storage 106. The present invention provides a method and system for identifying suitable combinations of parcels of land to construct these types of facilities.

FIG. 2 illustrates large areas of renewable energy sources 200 using solar across many acres and parcels of land that form a non-rectangular shape, according to an example of the present invention;

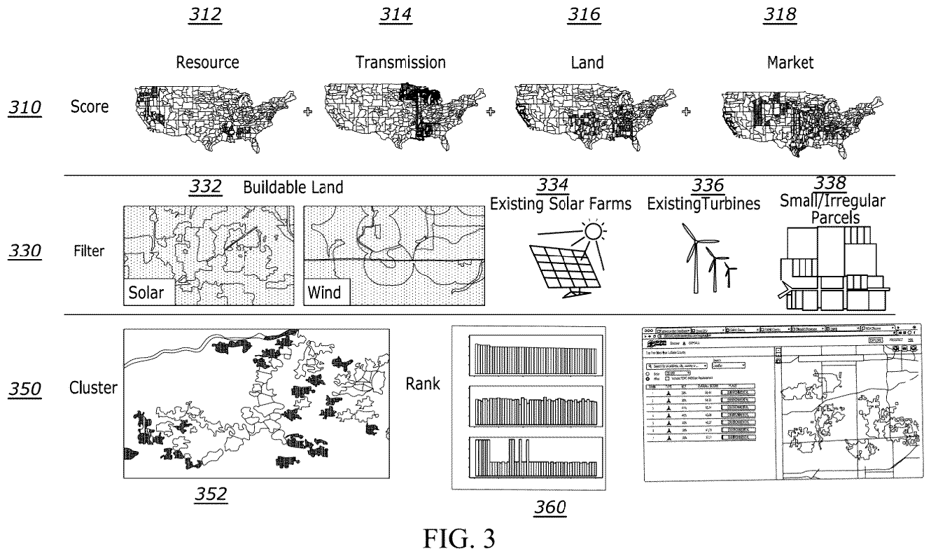

A high-level overview of one example of the present invention is shown in FIG. 3. More specifically, FIG. 3 is a pictorial overview 300 of the process. The process begins by looking at a variety of characteristics for each land parcel in a portfolio of land parcels. Characteristics include resource characteristics 312, transmission characteristics 314, land characteristics 316, and market characteristics 318. Next, filters 330 are applied to each parcel of land. Filters include buildable land 332, distance to nearby or existing solar 334 and wind turbines 336, and irregular and small parcels 338. After filters in 330, clustering 350 of each parcel of land in the portfolio is performed. The results are ranked that meet an electricity requirement combined with a highest combined score of a cumulative size of the subset of the parcels of land in the portfolio, the electricity transmission characteristics, and the market demand. These rankings are shown in user interface 360 as shown with color coding, charts, and other information, including overlays of maps as shown.

In one example, the system includes a prospecting tool that ranks every land parcel in the country based on the high-level characteristics that influence project viability. The goal is to improve the odds of a prospect of getting built and to reach a quicker conclusion.

The system combines all of the high-level factors that go into evaluating a successful prospect. Optional features may include: i) land parcel ownership, ii) evaluations extend nationwide in land parcel review, and iii) displaying relevant data layers that identify nearby features of significance.

The total score combines sub-scores, representing how feasible different components are and can be adjusted for different types of prospects. For example, this prospecting tool is used for data centers and battery energy storage site selections, and additional types of prospects beyond renewable energy, data centers, and batteries for a cluster of land are planned.

Scores are combined. The combined score means that a very low score in one category allows the tool to avoid “fatal flaws” or “low score escalators” with projects. That is, the identification of a potential “fatal flaw” is such that it ranks a group of land parcels much lower, eliminating them from consideration. For example, the fatal flaws may include very high transmission costs, very long gen-tie lines, and too many landowners in an area.

For each cluster of land parcels, the system provides an overall score, which is a weighted value based upon individual scores for resource, land, transmission, and market characteristics. Users can initiate a utility-scale wind or solar prospect within the user interface based on recommended clusters of land parcels, drawing their own candidate, or uploading external geospatial files.

The system quantifies the tradeoffs between resource, transmission, market, and land constraints that influence whether wind and/or solar project is successful. The ranking system identifies the best clusters of land parcels sufficient to build a utility-scale wind and solar farm and identifies those with the best combination of resource, transmission, and market characteristics while maximizing buildable land and minimizing land owners. In one example, the system evaluates enough clusters of land parcels to build 29 Terawatts of solar capacity spread across 1.1 million virtual solar farms and 5 Terawatts of wind capacity across 100,000 virtual wind farms across the contiguous United States. The virtual or potential wind and solar farms being ranked could provide 25 times the US total electricity capacity, giving developers a cache of actionable intelligence that can improve the wind and solar development process to significantly reduce carbon emissions of America's electric power generation critical infrastructure.

### Utility-Scale Wind/Solar Algorithm

The overall goal of the land parcel clustering is to recommend clusters of parcels that have sufficient transmission, resources, market demand, and available land to build a wind or solar farm. Considers land characteristics (Land Score), transmission characteristics (substation hardware costs, network upgrades, gen-tie cost), market characteristics (historical LMPs), and resource (wind/solar NCF) in producing clusters of land parcels that minimize the number of land owners, maximize buildable land, minimize transmission cost, maximize NCF, and maximize nodal LMPs.

### Stand-Alone Storage Algorithm

In one example, the present invention brings together the factors, such as, the proximity to the substation, battery arbitrage opportunities, and land parcel characteristics (buildable land and building footprints) that influence the viability of standalone storage prospects, ultimately recommending the best properties to pursue for these projects. The ultimate goal is to provide battery prospectors with recommendations of land parcels that have sufficient open land near substations that have good arbitrage opportunities. The system is also designed to generally highlight land and transmission characteristics more than market/arbitrage characteristics (until additional and more comprehensive arbitrage/load data), so users can pan on the user interface map based on displayed arbitrage values and then zoom into the appropriate scale for prospecting.

### Data Center Algorithm

In one example, the present invention brings together the factors including the proximity to fiber/population center/substation, land parcel characteristics, and more that influence the viability of data center prospects, ultimately recommending the best properties to pursue for these projects. Parcels within a small radius (typically 50 miles) of the center of major metro areas (top 100) are filtered and scored based on their proximity to fiber and transmission substations and land characteristics (number of buildings in parcel, concentration of buildable land for a data center, concentration of buildable land for a 25 MW solar plant).

### Technical Document

The overall goal of the land parcel clustering algorithm is to codify all of the major influences on wind and solar prospect viability for every land parcel in the country, based on interviews with developers, historical analyses, and financial/physical relationships. The present invention produces an algorithm recommending clusters of parcels with sufficient transmission, resources, market demand, available land, and positive land owner sentiment to build a wind or solar farm. Developers see the clusters of parcels in a given area that have the best chance of culminating in a constructed wind/solar farm without showing any areas with insufficient land for construction. In designing the clustering algorithm, the main goals are to 1) provide reasonable compact clusters of parcels with minimal land ownership and 2) score those clusters with the appropriate tradeoffs between transmission, resource, market demand, suitable/advantageous land, and land owner sentiment. Here, details about the clustering and considerations as development continues are considered.

Overall, the system filters and ranks all land parcels throughout the country based on a combination of transmission/land/market/resource scores and then clusters them together to form enough buildable land to build wind or solar farms of five different capacities. All clusters of land parcels are then scored based on their transmission/land/market/resource scores. Developers in the Discover User Interface can then view the top ten clusters of land parcels for wind or solar farms of a given capacity within the geographic area displayed in the user interface

### Documentation of Algorithm

In land parcel clustering, the process starts with reasonable objective assumptions that inform the weighting of score components and filtering of parcels. The process then continues by modifying the weighting of score components (resource/transmission/market/land as well as the components of the land score) to force the most appropriately shaped and ranked clusters.

### Development of Clustering Algorithm

Do the top ten options represent an appropriate mix of good transmission, good land, and good resource? Are they consistently dominated by one component?
Does the weighting/filtering penalize clusters that have very low scores in transmission, resource, or land?
   Great transmission but low available land/high land parcel density: retiring plant surrounded by acreages
   Great land surrounded by full substations
   Great land but a very poor resource
   Great resource but poor availability of land. For example, the following types of clusters may appear, such as many different land owners or sparse buildable land.
   Most appropriate weights that replicate variations in tax-efficient Levelized Cost of Energy (LCOE) and Levelized Cost of Transmission (LCOT)
   Modify weights based on examination of tradeoffs in cluster rankings

### Process

In one example, the process begins with identifying the technology type, such as solar farm, wind farm, energy storage, or data center, and the capacity desired.

Load nationwide data.
The code starts by loading nationwide gridded “ranker data” (nationwide grids of resource, transmission, and market characteristics/scores) that are produced by solar farm locations, wind turbine locations, and data intelligence and marketplace for land, such as the nationwide LandGate listings available at online URL <www.landgate.com>. Data gathered is arranged on a 1×1 km grid for solar over the continental USA and on a 2×2 km grid for wind.

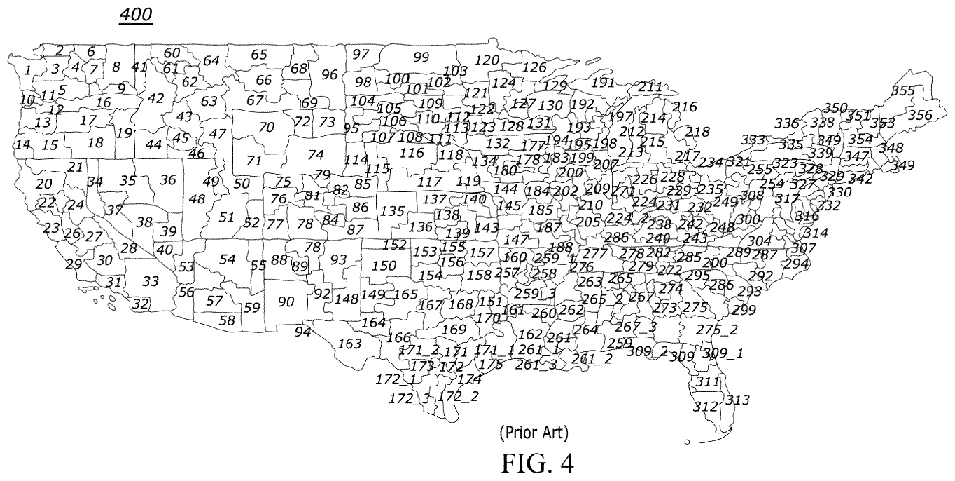

Turning to FIG. 4 is a pictorial view 400 of the 386 different multi-county regions in the continental USA derived from resource supply regions from NREL's Renewable Energy Deployment System (ReEDs), according to an example of the present invention.

### Loop Over Different Multi-County Regions Across Continental USA (CONUS).

In one example, the system runs nationwide. However, it loops over 386 different multi-county regions in the country, which are based on the resource supply regions of the ReEDs capacity expansion model (there were 356 regions, but several were broken into smaller sizes to reduce memory and denoted with suffixes like “1”, “2”, or “3”).

### Load Regional Data, Subset Region Data, and Merge Together

While in a particular clustering region, all of the filtered land parcel data, buildable land data, and tree cover data (if applicable) are loaded and merged together with the gridded “ranker data” and LandGate listings (defined above). In this manner, statistics about every single filtered land parcel in the region is processed, including parcel metadata, transmission costs/scores, market scores, NCFs, resource scores, total tree coverage (if applicable), buildable land area, LandGate listing information, etc.

### Score Land Parcels

All land parcels in a region are then scored and prepped for the clustering, which will be done for all filtered land parcels in a region

### Build all Possible Clusters Centered on Every Single Filtered Land Parcel

After loading and merging all the data, the system tries to build clusters starting at all land parcels of sufficient size (>5 acres) in the function for a given plant capacity, where it searches for all land parcels within a small radius (that scales by the farm capacity). It then ranks and sorts the parcel scores grouped by land owner and land parcel scores within a search radius (scaled to the capacity of the farm). Next the highest score parcels are selected from each owner until a sufficient buildable acreage is collected to support the construction of a plant of a given capacity. If not enough buildable land exists to build a plant of a given capacity, no clusters are built, and the system moves on to the next starting land parcel. The system also uses a distance score that adjusts all land parcels within the small search radius based on the distance from the centroid land parcel (starting parcel) and the distribution of scores in the search radius. This allows clusters to be generally more compact when they are initially built but has no impact on which clusters are eventually chosen when all possible clusters are ranked.
Distance score (temporary score introduced to give more weight to land parcels closer to the “starting land parcel.”
   To encourage the choice of parcels closer to the center of each cluster, a score is assigned to each parcel based on the distance from the starting parcel. This score is used only when sorting parcels and not in the final land score or total score.
   The “distance_score_subtractor” is simply the standard deviation (scores within the search radius for each cluster) multiplied by the distance from the starting parcel centroid/search radius. It is only applied when sorting by owner in the parcel clustering.
   To get the mean owner count score (defined further below) for the parcel clustering, the mean of all parcels by owner is calculated plus the minimum “distance_score_subtractor” for parcels associated with that owner. That way, the best parcels from owners that are generally close to the starting parcel are prioritized.
   The distance score is meant to prioritize land owners (and their parcels) closer to the center of the search radius, which produces more contiguous clusters in areas with many land owners. Because the system gathers parcels together by groups of land owners, the distance score generally has a negligible impact on the number of land owners but instead has a large impact on which land owners are chosen in areas with many owners of small parcels (it will choose owners closer to the center of the search radius).

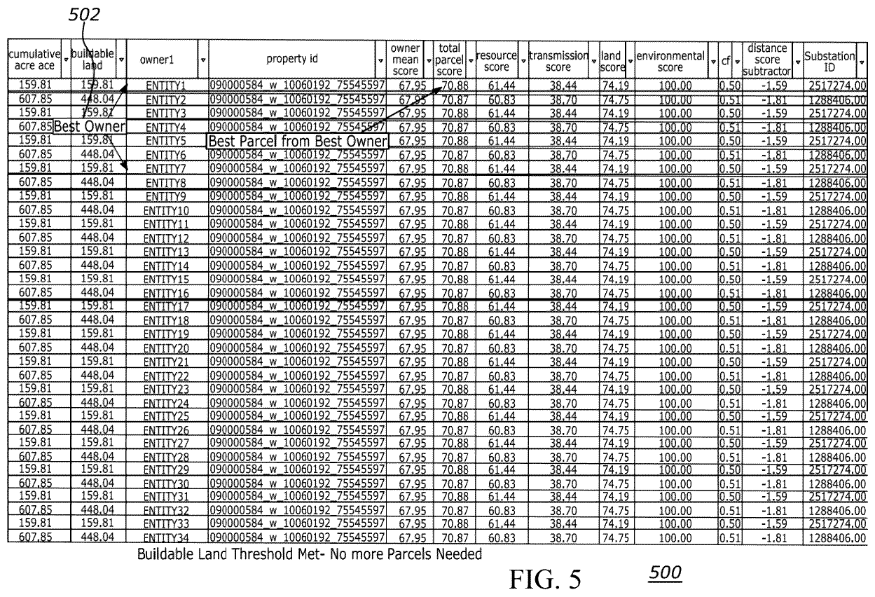

FIG. 5 is a table view of a cluster in Oklahoma 500, according to an example of the present invention. Note that the top three owners 502 appear to be the same but are structured differently.

### Rank all Possible Land Parcel Clusters

After building clusters around all filtered parcels with enough buildable land in the search radius, it sorts the clusters by score and removes any overlapping clusters with lower scores. The system iteratively chooses the best non-overlapping clusters until none are left or the specified number of clusters have been chosen. It also adds some ranking information to the output and formats/filters the output and saves it to a file for a national aggregation later.

### National Aggregation and Normalization

After all the regions have been run, the file outputs from each region are loaded sequentially, and then scores are normalized to a final 0-100 score.
All national files are outputted to S3, and the data is ingested into the Discover UI.

### Filtering

Filtering allows objective removal of non-buildable areas and tries to consider edge cases where appropriate without being too restrictive. Areas that provide marginal or atypical development potential are kept in the system but are generally scored lower.

### Wind Filters

Wind Buildable Land:
   One example makes use of a geospatial database. The geospatial database is a collection of land areas that can technically support the construction and permitting of wind turbines based on sufficient setbacks from existing building footprints, transportation corridors, transmission lines, pipelines, airports, protected lands, critical habitat, wetlands, operating wind farms, city limits, and areas prone to frequent flooding.
Existing wind farms (from USGS/AWEA database) with 10 km buffer
   Sources include: <https://eerscmap.usgs.gov/uswtdb>
Elevations >3000 meters
Parcels with very long/very scattered shapes: meant to remove transportation corridors and limited cases where all parcels with missing data in a county are grouped together
Parcels with small amounts of buildable land (scaled to farm size due to computing limitations)
50 MW: <2 acres of buildable land
100 MW: <4 acres of buildable land
150 MW: <6 acres of buildable land
200 MW: <8 acres of buildable land
300 MW: <12 acres of buildable land
Very large parcels with <10% buildable land (meant to remove very large parcels that typically don't have much contiguous buildable land)

### Solar Filters

Solar Buildable Land:
   One example makes use of a geospatial database. The geospatial database is a collection of land areas that can technically support the construction and permitting of solar farms based on sufficient setbacks from existing building footprints, transportation corridors, transmission lines, pipelines, airports, helicopter landing pads, protected lands, critical habitat, wetlands, steep slopes, city limits, and areas prone to frequent flooding.
Parcels with small amounts of buildable land (scaled to farm size due to computing limitations)
   25 MW: <0.25 acres of buildable land
   50 MW: <0.5 acres of buildable land
   75 MW: <0.75 acres of buildable land
   150 MW: <1.5 acres of buildable land
   250 MW: <2.5 acres of buildable land
Elevations >3000 meters
Parcels with very long/very scattered shapes: meant to remove transportation corridors and limited cases where all parcels with missing data in a county are grouped together and existing solar farms (from EIA)
Very large parcels with <10% buildable land (meant to remove very large parcels that typically don't have much contiguous buildable land)

### Assumptions

### Wind

Wind Farm Land Density (land_density): 60 acres/MW
Capacity: 50, 100, 150, 200, 300 MW
Buildable_frac_in_radius (0.2) is the fraction of buildable land required in the search radius for building a cluster. If not enough options are showing up in an area, then the search radius can be increased by reducing Buildable_frac_in_radius.
Search radius (in km): (([1/buildable_frac_in_radius]*land_density*Capacity)/(247*pi)), where 247 is the number of acres per square kilometer. It is the radius of a circle that makes an area large enough to produce five (1/buildable_frac_in_radius) times the buildable land desired (a wind farm can be built if 20% of the land in that radius is buildable)

### Solar

Solar Farm Land Density (land_density): 12 acres/MW, approximately 150% of the final density for solar farms (according to meet market requirements for Northeastern/Southeastern U.S.) to allow for secondary land options when signing up land owners, and to give more spatial variety of cluster options
Capacity: 25, 50, 75, 150, 250 MW
Buildable_frac_in_radius (0.25) is the fraction of buildable land required in the search radius for building a cluster. If not enough options are showing up in an area, then the search radius can be increased by reducing Buildable_frac_in_radius.
Search radius (in km): (([1/buildable_frac_in_radius]*land density*Capacity)/(247*pi)), where 247 is the number of acres per square kilometer.

### Score Components and Weights

### Resource Score

The Resource Score (100=best, 0=worst) describes the relative strength of the wind/solar resource over a given cluster of land parcels. It is calculated by converting NCF estimates for each 1×1 km solar grid cell and each 2×2 km wind grid cell into a 0-100 score. To do this, the distributions of wind and solar NCFs are extended from the 5th percentile to the maximum to get 0-100 scores for wind and for solar independently. Resource scores are calculated for each land parcel based on weighted area averages of grid cells within a parcel, which helps determine which parcels are chosen by the clustering algorithm. Resource scores are also calculated for each cluster based on the weighted area average of resource scores from each land parcel.
An area-weighted average of resource score in the cluster
Weight for overall score: (wind=0.375, solar=0.2)

### Transmission Score

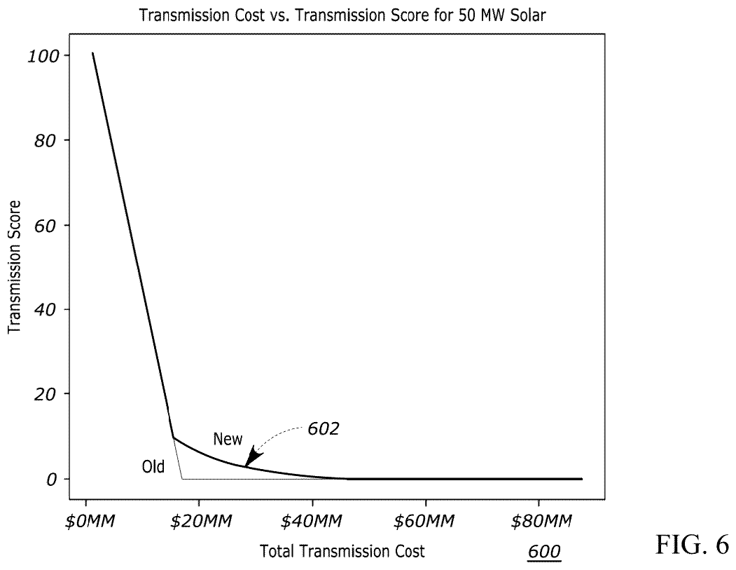

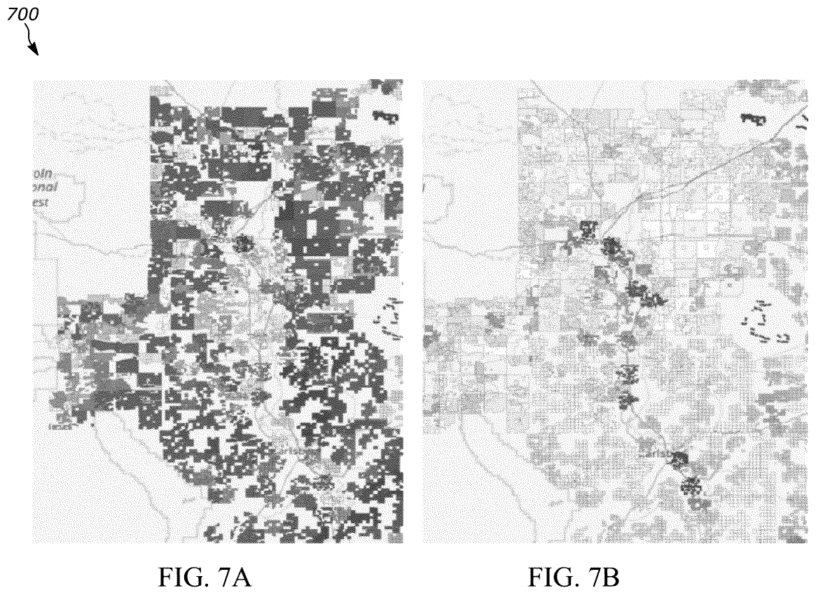

FIG. 6 is a graph of transmission costs versus transmission scores 600, according to an example of the present invention.
The Transmission Score (100=best, 0=worst) describes how characteristics about the transmission network (congestion, queue positions, substation/tap costs, gen-tie line length) can ease project advancement or present barriers to development. It is calculated by converting the sum of the network upgrade costs, interconnection facility cost, and cost to a 0-100 score for the cheapest bus out of the 100 closest intrastate busses or the cheapest line tap. Gen-tie line is an industry term that means the generation-intertie overhead electric line that will connect the wind/solar project substation to the utility substation owned by the transmission owner. Note that region 602 illustrates the exponential score decay enables gen-tie length to influence score at a very high cost.
The transmission score of a cluster is based on the highest transmission score from any of the closest gridded points (transmission scores are calculated for wind and solar grids) within the cluster, whether that connection is to an existing substation or for a new line tap.
Example weight for overall score: (wind=0.25, solar=0.35)

### Market Score

The Market Score (100=best, 0=worst) quantifies the market conditions for developing wind or solar in a given location. This is determined by calculating the 40th percentile of generation-weighted LMPs (for wind and for solar) using hourly energy time series and hourly historical LMPs from analytical software for the energy industry, such as Velocity Suite available from Hitachi Energy, using the median and standard deviation of generation-weighted LMPs and assuming a gaussian distribution. The system then converts them to a 0-100 score by converting the distribution of generation-weighted LMPs to 0-100 (modifying them so that the highest generation weighted LMPs are 100) within each ISO. In one example, the system uses the 40th percentile to effectively penalize nodes with substantial variability/risk (which is not advantageous unless doing arbitrage) while still choosing a value close to the median.
The market score of the highest-scoring bus (based on the weighted average of transmission score and market score for all grids in the cluster) for any grid point within the cluster
Weight for overall score (wind=W, solar=D)

### Land Score

The Land Score (100=best, 0=worst) describes the land characteristics that influence the feasibility of completing a project. It is the weighted sum of the Parcel Size Score, Owner Count Score, Buildable Land Score, Land Cost Score, and Environmental Score. The Buildable Land Score is a 0-100 score that scores the amount of buildable land in the vicinity (0=least land, 100=most land). The Land Cost score estimates the relative cost of tree clearing costs on a land parcel. The Environmental Score uses a count of relevant environmental layers from the Nature Conservancy, converted to a 0-100 score (0=most layers, 100=no layers), for each parcel and averaged over the cluster.
Sum of land score components (see below), which are a mix of weighted area averages of parcels and cluster summary statistics.
Turning to FIG. 7A and FIG. 7B are pictorial maps 700 of color-code land score values with various filters, according to an example of the present invention. Shown are land scores overlaid on a map as shown (green=100, red=15).
Weight for overall score (wind=0.25, solar=0.35)

### Land Score Components

In one example, different land scores are added that form appropriate cluster shapes and give a proper ranking of clusters. The system uses scoring to pick the best parcels within a cluster and rank the clusters based on land/transmission/resource/market.

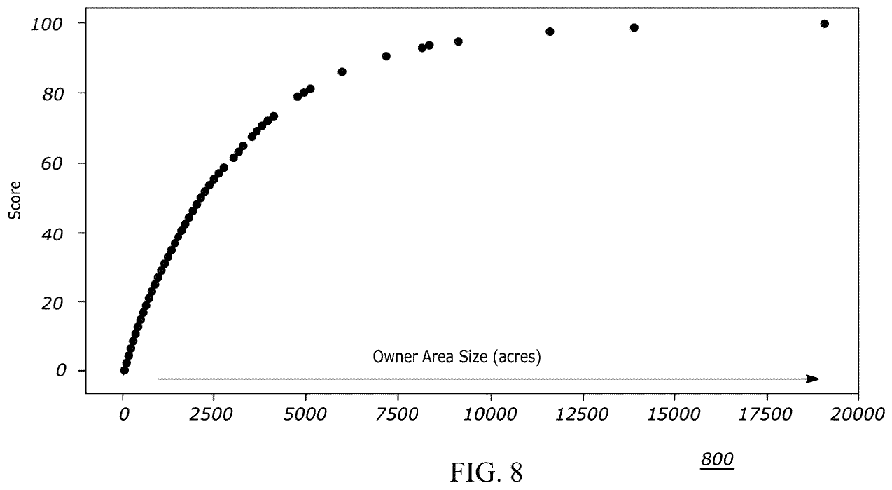

Turning to FIG. 8 is a graph of Parcel Size Score versus land owner's parcel size 800, according to an example of the present invention.

Parcel Size Score: Wind Weight=0.42, Solar Weight=0.25 (for calculation of Land Score)
The Parcel Size Score is designed to nudge the recommendations towards larger land parcels, and larger swaths of single-owner occupied land. It is assigned based on the total buildable acreage by owner in the search radius of a starting parcel (0=tiny parcels, 100=giant single owner swaths of land).
Each parcel gets assigned a Parcel Size Score based on the size of common parcels from each owner in the search radius, which influences which parcels get chosen by the clustering algorithm and favors the choice of big swaths of parcels from the same owner within the clustering algorithm.
The score assigned to each parcel is based on the total owner area within the search radius. The equation uses a variable “parcel_size_cost_coefficient” which varies between wind/solar and modifies the steepness of the curve. For solar, the owner area size curve is steeper to prioritize differences at smaller parcel sizes
Each cluster's Parcel Size Score is the weighted area average of parcel size score, which favors clusters with large swaths of land.

Owner Count Score: Wind Weight=0.37, Solar Weight=0.35 (for calculation of Land Score)
The Owner Count Score is meant to nudge the recommendations towards clusters of land parcels that have fewer land owners, preferably one. It is an exponentially decaying score with each additional land owner in a cluster, starting at a score of 100 for one owner and approaching zero for ten land owners for solar and 50 land owners for wind. The equation uses a variable “owner_score_coefficient” which varies between wind/solar and modifies the steepness of the curve, with a steeper curve for solar than wind that is designed to give more priority to minimizing the number of land owners for solar than for wind.

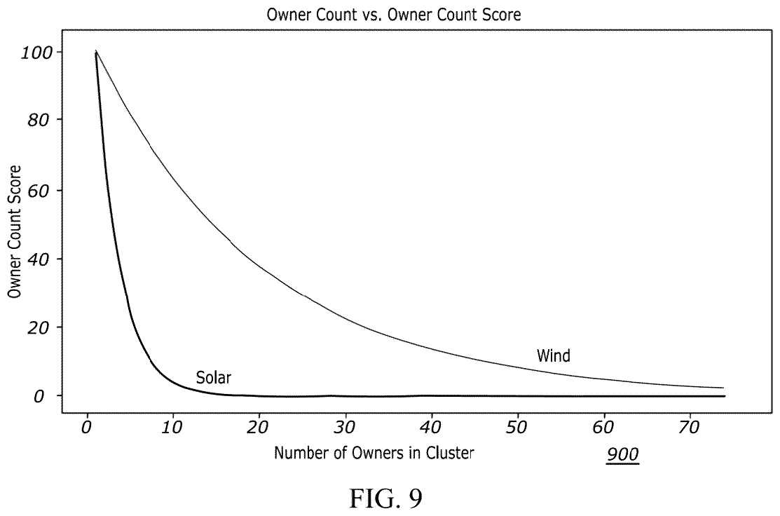

FIG. 9 is a graph of Owner Count Score versus the number of owners 900, according to an example of the present invention. For solar, the owner score drops much faster to emphasize the greater desire to minimize the number of land owners for solar compared to wind.

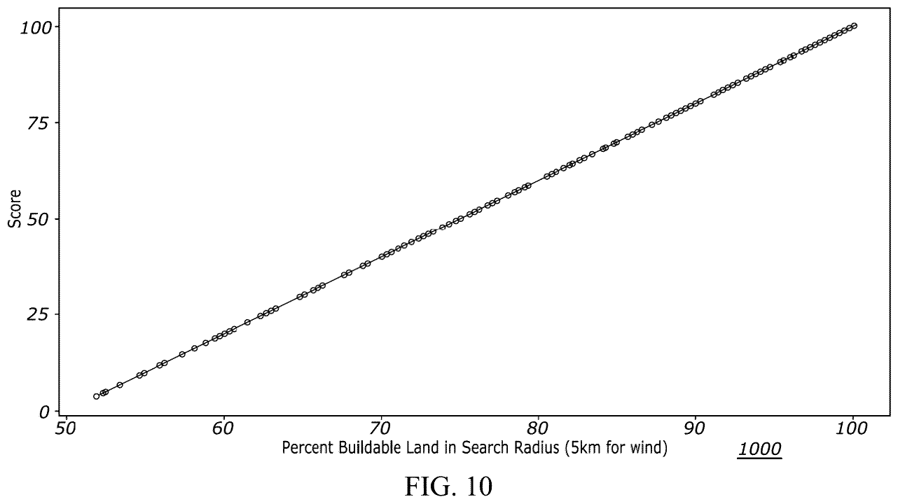

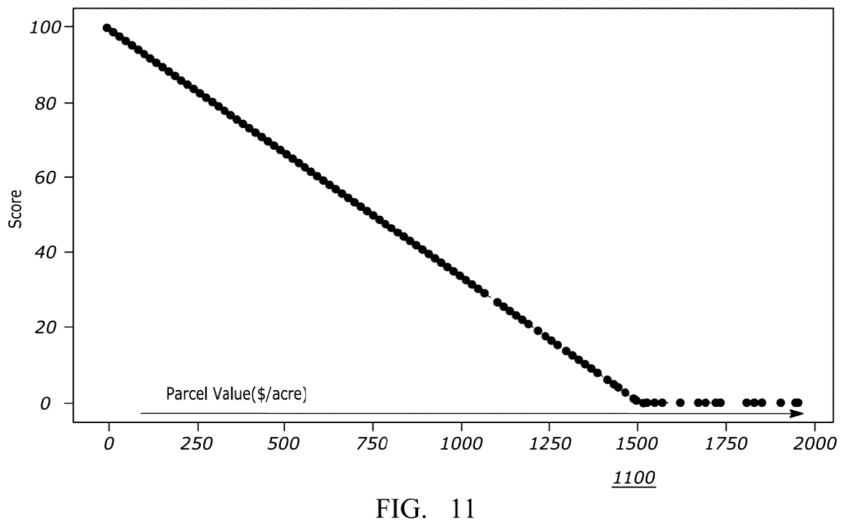

Buildable Land Score: Wind Weight=0.21, Solar Weight=0.20 (for calculation of Land Score).
The Buildable Land Score is meant to nudge the recommendations towards clusters of land parcels that are in areas with fewer potential land constraints. A 0-100 score scores the amount of buildable land in the vicinity (0=least land, 100=most land), with a declining score with each percent of available buildable land. A typical range may be from 20% to 100% buildable.
FIG. 10 is a graph of the score of a parcel of Buildable Land Score versus the percentage of buildable land in a search radius of 1000, according to an example of the present invention. In this example, 5 kilometers are used for wind, which is the approximate search radius for a 50 MW wind farm. As shown, the system favors clusters with large amounts of buildable land available in ranking.

Land cost score: Weight=0.2 for solar, 0 for wind
The Land Cost Score is designed to shift the recommendations from the system away from areas that may have prohibitive construction costs. It is based on the percent of the buildable land that is not covered in trees, according to the US Forest Service Tree Canopy Cover Database.
In one example, land cost score=100-2*percent tree coverage in buildable land of the parcel (e.g., 25% tree coverage on buildable land=land cost score of 50).
The Land Cost Score has increased weight as the Land Cost score decreases below a certain threshold (50%, which corresponds to 25% tree coverage), canceling out any benefit from large land parcels or a small number of land owners in a cluster. The goal here is to give a benefit to parcels/clusters with low tree coverage (high land cost score) while also having a prohibitive cost penalty once the tree cover exceeds a defined value so that large heavily tree-covered clusters (typically National/State Forest lands or timber company properties) are not favored by the system even if they have other favorable land characteristics such as a single owner.

Land value score: Weight=0 to 0.05
FIG. 11 is a graph of the score of a parcel of land versus parcel value 1100, according to an example of the present invention. Much of the land value data may be incomplete and does not warrant inclusion in the land scoring algorithm. It will increase to 0.05 when land rental rates are accessed for each parcel based on USDA county-level rental rates and satellite info about cropland/non-cropland.

### Low Score Escalators

Very poor land characteristics, very high transmission costs, or very low wind resources can have a very large negative impact on the viability of a recommended cluster, yet their scores can be relatively high if other score components are high. In order to increase the influence of these very low scores on the total score (and which particular clusters are recommended in the user interface), any land/transmission/resource score that is very low (<10) has a linearly increasing weight that also decreases the weight of other categories (to a minimum of 0.05). In this manner, a cluster with a transmission score of 0 will have a total score of 15 if other scores are 100 (without this weighting, such a wind prospect would have a score of 75 (assuming a transmission weight of 25%).

### Sentiment Score Boost

The addition of third-party (LandGate in this case) advertisements from land owners about their desire to lease their land for wind, solar, or other mineral rights can help address another potential hurdle to renewable development: land owner sentiment. Combining this with Discover's core system gives users further insights into the main drivers of prospect viability

LandGate is a website where land owners advertise their land for mineral/renewables leases, providing a powerful avenue to identify willing land owners. The system uses sentiment scoring, to prove a conditional score boost to land parcels (and clusters) that have land owners advertising their land for renewable (or other) leases on third-party websites like LandGate via a Sentiment Score Boost. The system also gives a partial Sentiment Score Boost to any additional land parcels nearby that the system identifies are owned by a land owner that advertised their land for renewable energy leases.

The Sentiment Score Boost is applied to each parcel (100 if the listing is in the same technology being considered in the algorithm, 75 if it is another renewable technology, 50 if it is oil/gas/mining or other properties owned by a “lister”), apply a Sentiment Score Boost based on the total score of the parcel 1200, cluster parcels together based on parcel scores and methods described previously, recalculate total scores, and then apply a sentiment boost to the cluster based on a weighted area average of the sentiment scores for parcels in the clusters.

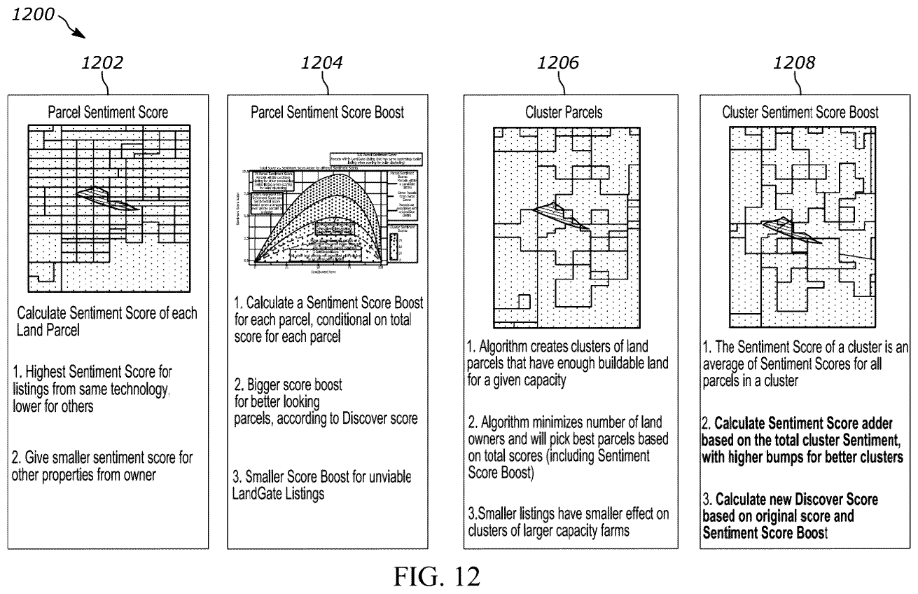

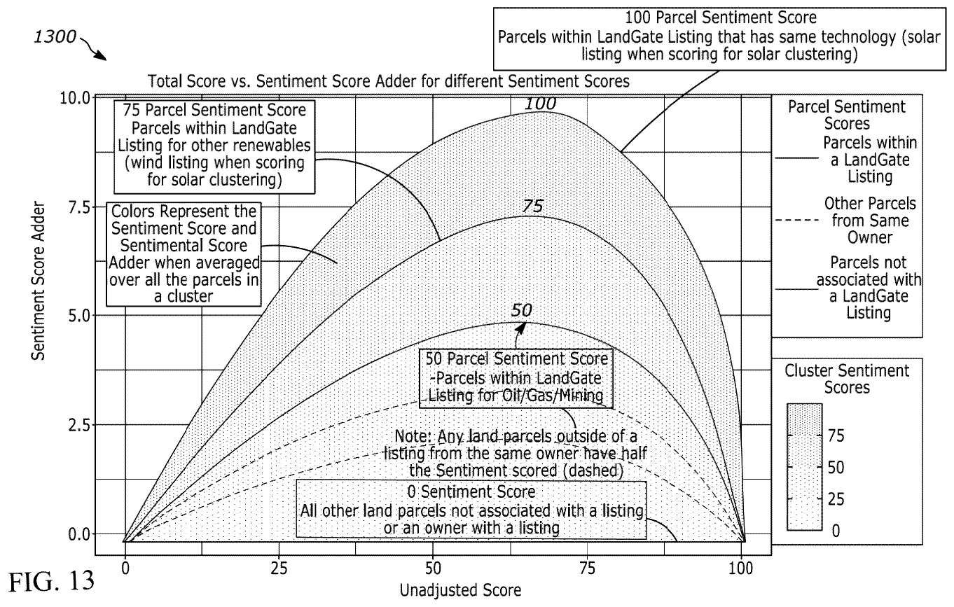

FIG. 12 is a series of pictorial diagrams 1200 representing parcel sentiment score 1202, parcel sentiment score boost 1204, parcel clustering 1206, and cluster sentiment score boost 1208. FIG. 13 is a graph of sentiment score adder versus unadjusted score 1300.

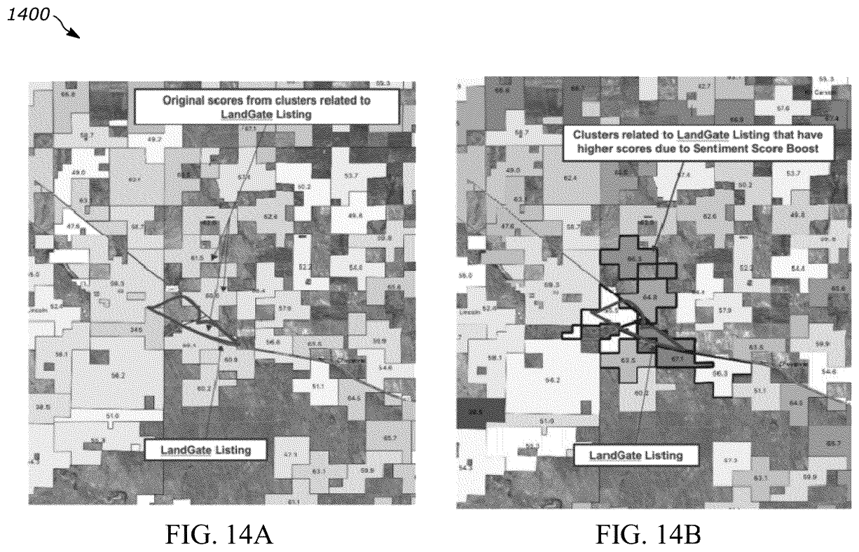

FIG. 14A and FIG. 14B are pictorial maps 1400 of color-code sentiment boost score values with various filters, according to an example of the present invention.

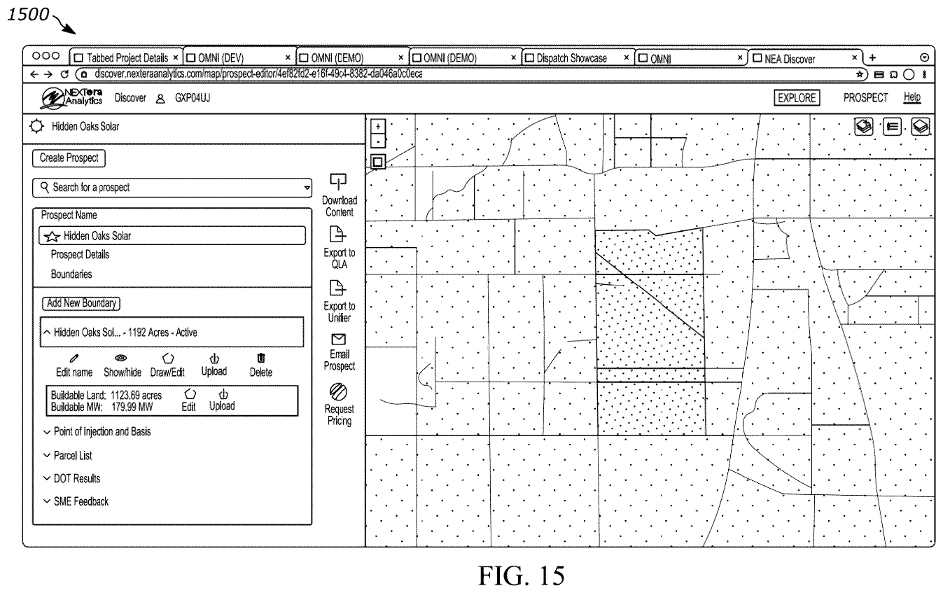

FIG. 15 is an example of a user interface 1500 that illustrates a pictorial map of color-coded solar prospects recommended by the system with buildable land highlighted, according to an example of the present invention.

### Discover Score

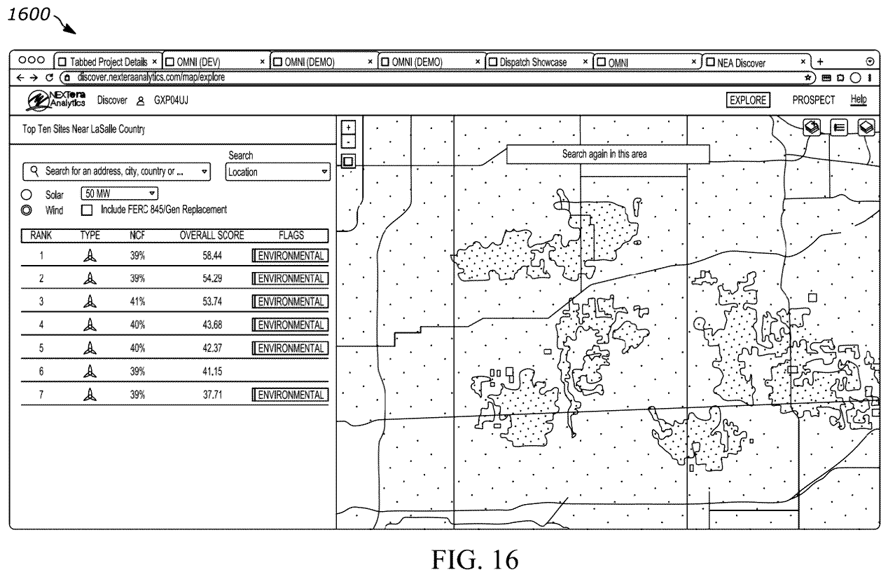

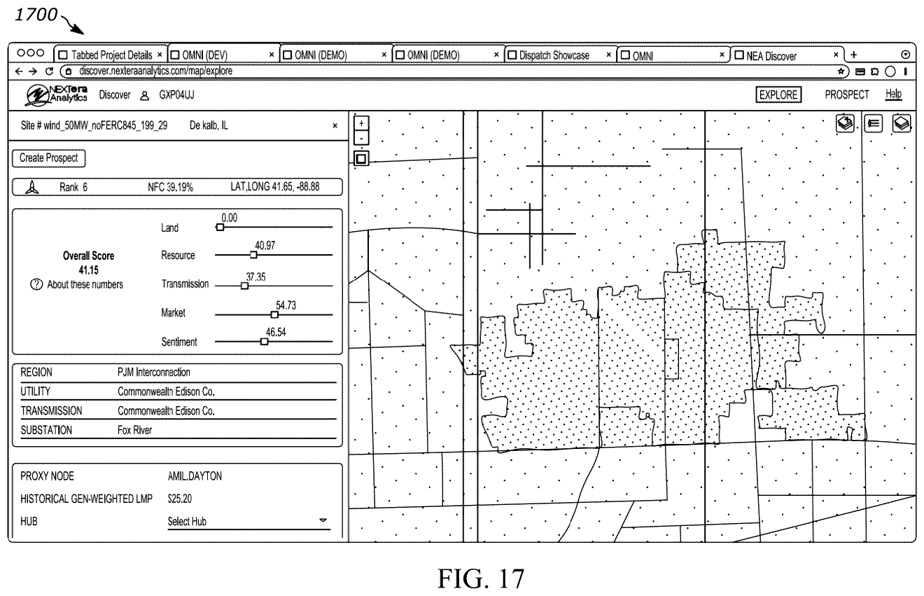

Scores are normalized to a 0-100 scale by linearly stretching the distribution of weighted average scores.
FIG. 16 is an example user interface that illustrates a pictorial map 1600 of color-code of wind clusters recommended wind cluster of land parcels, including overall score characteristics, plus resource characteristics, land characteristics, transmission characteristics, and other sub-scores, according to an example of the present invention. Land Parcels with a high sentiment score and a high score receive a larger sentiment score boost
FIG. 17 is an example user interface that illustrates a pictorial map 1700 of color-code of wind clusters recommended wind cluster of land parcels, including overall score characteristics, plus resource characteristics, land characteristics, transmission characteristics, and other sub-scores, according to an example of the present invention. As documented elsewhere on this page, the system creates clusters of land parcels that have enough buildable land for a given capacity

### Flow Diagram for Identifying Land Parcels for Solar, Wind of Storage

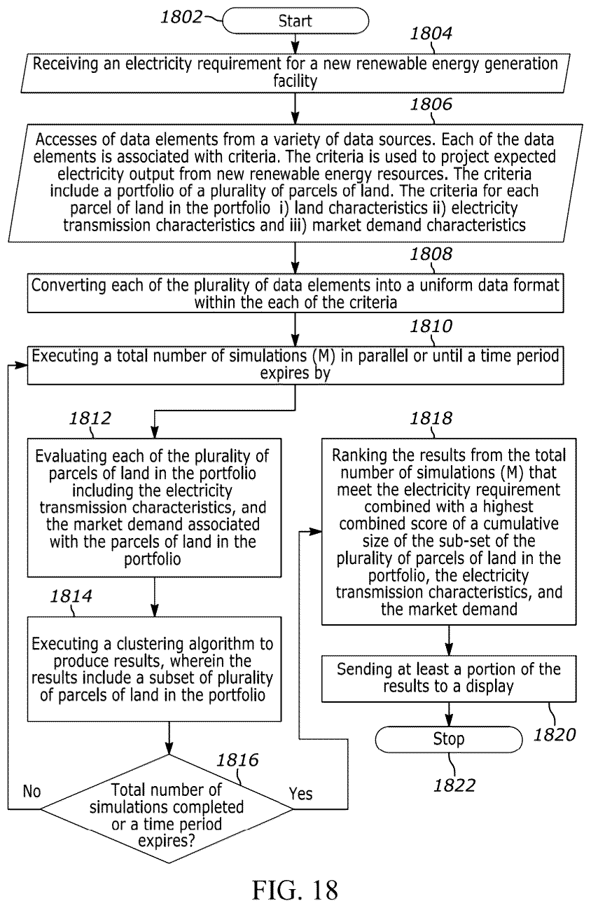

Turning now to FIG. 18, shown is a flow method 1800 for identifying parcels of land to construct a renewable energy generation facility to generate electricity, according to an example of the present invention. The process begins in step 1802 and immediately proceeds to step 1804, where a plurality of projections is performed. The projections begin with receiving an electricity requirement for a new renewable energy generation facility. This electricity requirement is typically expressed in megawatts of power. The process continues to step 1806.

In step 1806, data elements are accessed from a variety of data sources. Each of the data elements is associated with criteria. The criteria is used to project expected electricity output from new renewable energy sources. The criteria include a portfolio of a plurality of parcels of land each with i) land characteristics, ii) electricity transmission characteristics and iii) market demand characteristics.

In one example, the criteria of land characteristics for each parcel of land in the portfolio may be any combination of electricity transmission characteristics of the parcel, market demand characteristics of the parcel. Further, these criteria may include any combination of the size of the parcel, ownership of the parcel, tree coverage in the parcel and/or tree clearing costs, the elevation of the parcel, terrain of the parcel, buildable land area of the parcel, location of the parcel to nearby renewable projects, or a land owner's willingness to grant rights to the parcel, i.e., sentiment score boost. Other criteria for each parcel of land in the portfolio may include the plurality of criteria further includes at least one resource score that is based on the strength of the wind or solar in each of the plurality of parcels of land.

In another example, the criteria of transmission characteristics for each parcel of land in the portfolio may include the size of substation hardware costs, network upgrade costs, or grid tie-in costs. The process continues to step 1808.

In step 1808, each of the plurality of data elements is converted into a uniform data format within each of the criteria. The process continues to step 1810.

In step 1810, the process begins a loop in which a total number of simulations (M) are executed in parallel up to the total number of jobs or until a time period expires by step 1812 and step 1814.

In step 1812, by evaluating each of the plurality of parcels of land in the portfolio, including the land characteristics, the electricity transmission characteristics, and the market demand associated with the parcels of land in the portfolio. Next, in step 1814, a clustering algorithm is executed to produce results, wherein the results include a subset of the plurality of parcels of land in the portfolio. The process continues to step 1816. If the number of simulations is complete or time period expires, the process continues to step 1818. Otherwise, the process returns to step 1810.

In step 1818, the results are ranked from the total number of simulations (M) that meet the electricity requirement combined with a highest combined score of a cumulative size of the subset of the plurality of parcels of land in the portfolio, the electricity transmission characteristics, and the market demand. The process continues to step 1820.

In step 1820, the results may be displayed in various formats with various color overlays on maps illustrating the combination of the parcels of land with the highest ranking for development based on the criteria. The process ends in step 1822.

### Overview for Hydrogen Generation-Embodiment

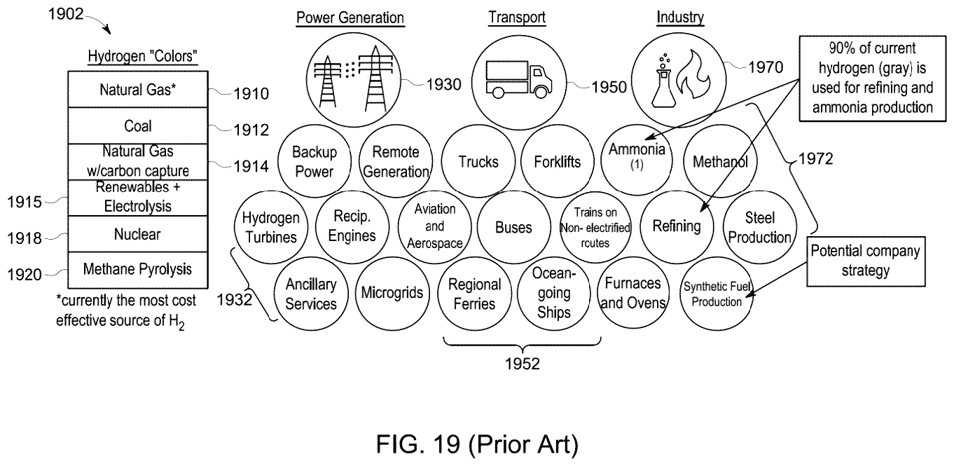

Turning now to FIG. 19 illustrates types of hydrogen generation and uses in power generation, transportation, and industry. Hydrogen can be produced from a range of resources, including fossil fuels, nuclear energy, biomass, and renewable energy sources. This can be done via a number of processes. On the left are the “colors” 1902 of hydrogen production. Grey hydrogen 1910 is the most common form and is generated from natural gas, or methane, through a process called “steam reforming”. This process generates just a smaller amount of emissions than black or brown hydrogen 1912, which uses black (bituminous) or brown (lignite) coal in the hydrogen-making process. Black or brown hydrogen is the most environmentally damaging as both the CO₂ and carbon monoxide generated during the process are not recaptured. Blue hydrogen 1914 is the carbon generated from steam reforming captured and stored underground through industrial carbon capture and storage. Green hydrogen 1916, also referred to as “clean hydrogen”, is produced by using clean energy from surplus renewable energy sources, such as solar or wind power, to split water into two hydrogen atoms and one oxygen atom through a process called electrolysis. Renewables cannot always generate energy at all hours of the day, and green hydrogen production could help use the excess generated during peak cycles. Then there is pink hydrogen 1918. Like green hydrogen, it is created through the electrolysis of water, but the latter is powered by nuclear energy rather than renewables. Turquoise hydrogen 1920 refers to a way of creating the element through a process called methane pyrolysis, which generates solid carbon.

The many end-uses for hydrogen make it a leading pathway to decarbonize many parts of the U.S. economy via green hydrogen production. Hydrogen is used throughout the US economy. Illustrated are three major sectors of the economy power generation 1930, transportation 1950, and industry 1970. Below each of the three major sections 1930, 1950, 1970 are further details on each sector 1932, 1952, and 1972 as shown.

Reviewing the industry section 1970, the inventors have identified ammonia production, refining, and synthetic fuel production are good candidates for deploying renewables via green hydrogen.

In this embodiment, the focus is on green hydrogen 1916, which uses renewable energy, plus an electrolyzer or electrolysis. The goal is to achieve cost parody compared to gray hydrogen 1910 in these existing markets for refining and ammonia production. Another goal is synthetic fuel production (synthetic natural gas, methanol, etc.), which is becoming more cost competitive due to recent tax incentives. However, in general, green hydrogen 1916 is typically much more expensive than gray hydrogen 1910. The cost to generate green hydrogen 1916 is dependent on the characteristics of the location it is being produced. The characteristics include regional construction costs, average wind speed to power wind turbines, average incoming solar radiation for photovoltaic (PV) solar, infrastructure, distance to distribution networks like roads and pipelines, the costs to purchase electricity, the price to sell renewable energy, and several other factors.

To achieve a cost parody of green hydrogen 1916 with this existing market for gray hydrogen 1910 is dependent on both the tax credit and location. This embodiment provides a method and a system to identify a location to produce green hydrogen 1916 at cost parody with gray hydrogen 1910, and where it can be most easily sold to customers.

### H2Viewer and HDOT Overview

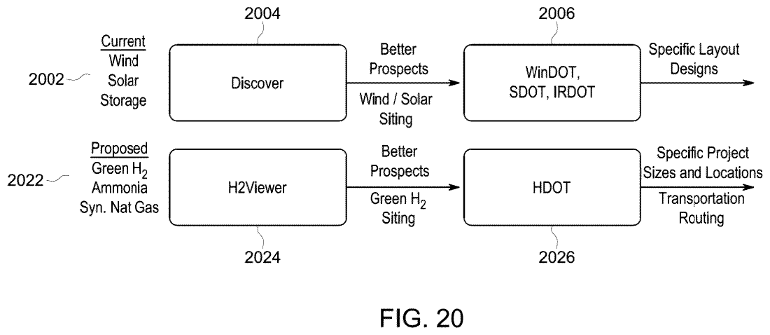

FIG. 20 illustrates a high-level view of two new tools i) H2Viewer 2024 and ii) HDOT (Hydrogen Design Optimization Tool) 2026, and their relations to previous tools 2002, 2004, 2006 (see FIG. 3) previously described above, e.g., specifically WINDOT (Wind Design Optimization Tool), SDOT (Solar Design Optimization Tool) and IRDOT (Integrated Resource Design Optimization Tool).

The H2Viewer is a green hydrogen site prospecting/screening tool that identifies focus areas for development & origination efforts. HDOT is a green hydrogen design optimization tool that identifies the lowest cost architecture to meet customer-specific product desires: product type, delivery point, volume, and term. The green hydrogen system utilizes a prospecting and optimization application to filter for the best locations, then conduct complex project design/financial math for customizable projects.

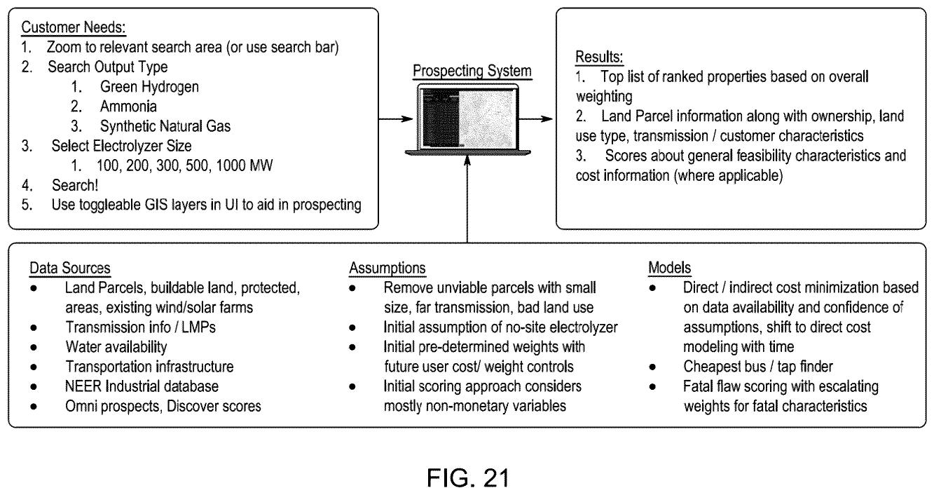

FIG. 21 illustrates a high-level view of the new H2Viewer tool 2024 of FIG. 20. The green hydrogen prospecting algorithm in the H2View tool 2024 ranks and recommends promising properties based on relevant criteria and provides better prospects for the optimization model HDOT 2026.

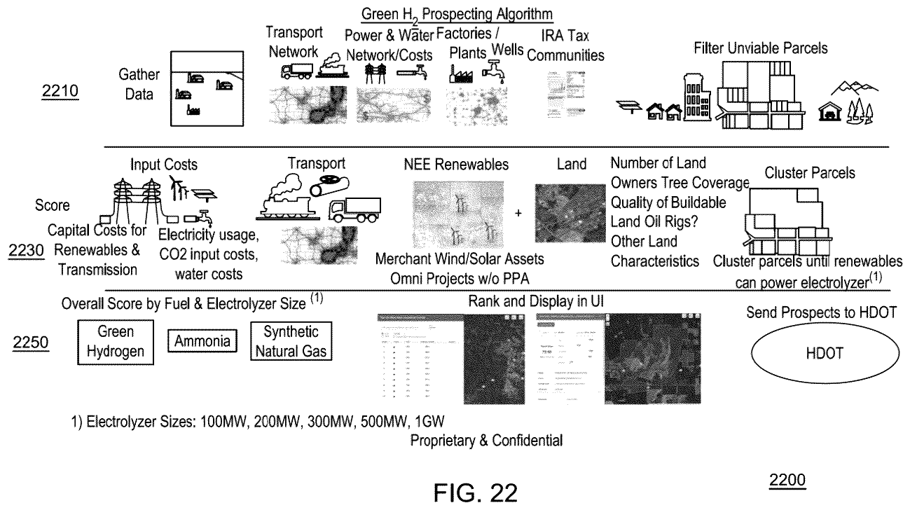

FIG. 22 illustrates a high-level view of the new H2Viewer tool 2024 prospecting algorithm 2200. There are three major components of the prospecting algorithm i) gather data 2210, ii) score 2230, and iii) rank and display 2250 as shown.

The H2Viewer Tool 2024 includes various user interfaces (UIs) in which the users, such as hydrogen developers or analysts that are helping hydrogen developers, find the best sites. Interacting with the UI, the user can pan and zoom to the right area, enter an address, and enter in latitude and longitude or other location information to select a location of interest. They can select the fuel type, which in this example is green hydrogen 1916, but they can also select ammonia or synthetic natural gas. Next, the user selects the size of the desired electrolyzer and selects the search icon. In response to the prospecting algorithm, a list of ranked properties or clusters of land parcels based on overall scoring of four main categories. They also get information about land, parcel and ownership, transmission, land use, type of customer characteristics, etc. The H2Viewer Tool 2024 displays the scores for each category that show the general feasibility of such an option. The H2Viewer Tool 2024 embodiment provides high-level information to developers so they can see what are the best areas, what are the best landowners to consider, and a litany of other information related to the viability or cost of building a green hydrogen facility at that location.

In one example, the prospecting algorithm examines five different electrolyzer sizes (100 megawatts, 200 megawatts, 300 megawatts, 500 megawatts, and 1000 megawatts), but other numbers of electrolyzer sizes are within the scope of the present invention. The electrolyzer size describes as the size of the equipment to produce green hydrogen from water using electrolysis. And then, the size of the clusters are dependent on the amount of land, and the land prices, desired to fully power that size electrolyzer on a net basis using renewable energy for the whole year.

Next, hourly modeling is performed for a given cluster of land to predict how much energy will be produced by renewables. The amount of energy produced by the renewables also determines the amount of energy to be purchased from the grid. These models the impact on wholesale electricity prices at that location based on those time series. Stated differently, the prospecting algorithm 2220 scores higher in response to clusters with complementary wind and solar, in which it is not necessary to pull from the grid at higher prices. While at the same time, there is not so much renewable capacity requiring excess renewable energy yet to be sold at suppressed prices based on the prospecting algorithm 2200.

The prospecting algorithm 2200 considers whether a location is sunnier or winder. Depending on the characteristics of the given location, the prospecting algorithm 2200 may emphasize more wind than solar renewable energy. And vice-versa, if the location is a good location for solar, then prospecting algorithm 2200 may emphasize more solar than wind while simultaneously minimizing the number of landowners by correlating with contiguous parcels of buildable land within one landowner's property. This embodiment includes additional cost modeling that is weighted between a 0 to 100 score.

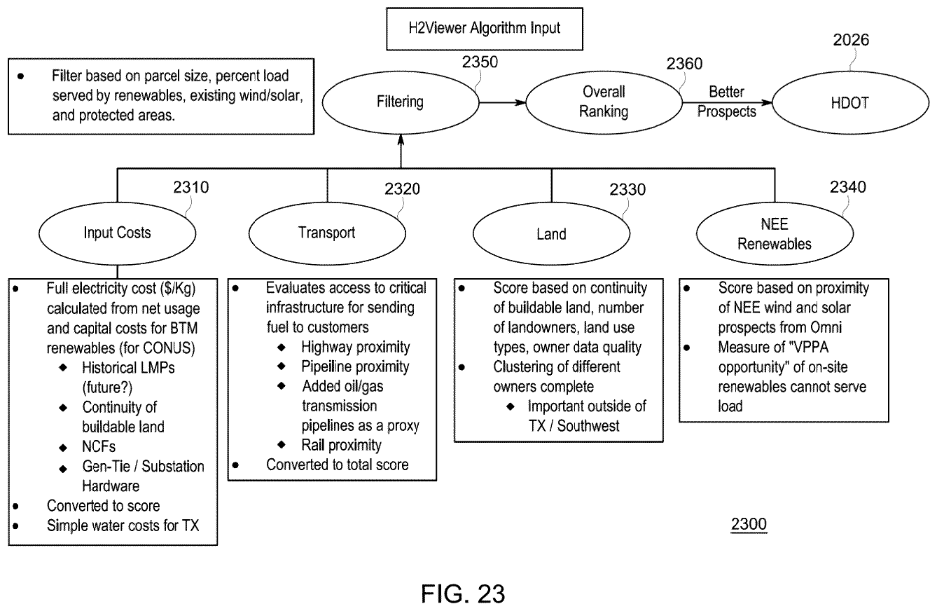

FIG. 23 illustrates a high-level view of the inputs used with the H2Viewer tool 2024. In general, the system is simultaneously scoring and clustering many parcels using information that includes the transportation network (highways and railroads), power electricity network, water networks, power, and water costs, factories whether to supply CO2 for synthetic fuel generation or is a prospective customer or consumer of the hydrogen generated, ethanol plants and water wells, information about community such as local tax incentives and willingness to participate in hydrogen project.

More specifically shown are four inputs: i) input costs 2310, ii) transport 2320, iii) land 2330, and iv) renewables 2340. The input costs 2310, as shown, includes full electricity cost ($/kg) calculated from net usage and capital costs for behind-the-meter (BTM) renewables for the contiguous United States (CONUS), historical locational marginal pricing (LMPs), continuity of buildable land, net capacity factors (NCFs), gen-tie/substation hardware, converted to score, and water access costs. The transport 2320, as shown, evaluates access to critical infrastructure for sending fuel to customers, highway proximity, pipeline proximity, oil/gas transmission pipelines, and rail proximity, converted to a total score. The land 2330, as shown, includes a score based on the continuity of buildable land, number of landowners, land use types, owner data quality, and clustering of different owners complete. The renewables or NEE renewables 2340, as shown, include a score based on the proximity of NEE wind and solar prospects, a measure of a virtual power purchase agreement (VPPA) opportunity if on-site renewables cannot serve load. A VPPA is a type of contract that allows consumers, typically large commercial entities, to form an agreement with a specific energy-generating unit. These types of contracts, typically secure a long-term stream of revenue for an energy project by providing the energy off-taker a steady cost of electricity.

Also shown in FIG. 23 is filtering 2350. In general, the unviable parcels are filtered out based on characteristics, such as having existing wind turbines or solar panels or being identified as having proposed wind and/or solar plants. The filtering also removes protected areas or small land parcels. More specifically, the system filters the inputs described based on the parcel size, percent of load served by renewables, existing wind/solar, and protected areas.

Next, the system scores all the parcels based on things including input costs, which involves the capital cost for building the renewables and the transmission, all the costs around electricity usage, the revenue that could be gained from selling the renewables, CO₂ input costs, and water access costs. Certain fuel types can have different pathways to transport that fuel, and the system scores based on how close it is to a transport pathway (highways for liquid hydrogen, pipeline corridors for gaseous hydrogen) or renewable projects that may be used for power purchase agreements. The system scores based on characteristics such as the number of landowners among other things. The system essentially clusters parcels together until they have enough energy to power the proposed electrolyzer. And then, depending on the fuel type, different weights are applied. And different categories are scored, such as, if it's green hydrogen versus ammonia versus synthetic natural gas. These all get ranked and displayed in the UI, and different clusters of land and parcels can be chosen based on their rankings and what is appropriate to develop and then send those prospects on to get further scrutiny and further detail in this other tool called HDOT.

Next, the process goes to an overall ranking 2360, and then the system feeds the results into the hydrogen design optimization (HDOT) 2026.

### Details on H2Viewer Algorithm

H2Viewer is a prospecting/screening tool that enables hydrogen developers to more quickly identify which areas are the most promising for building a wind with solar with electrolyzer (“co-located green hydrogen”) site based on high-level characteristics. The high-level characteristics include the cheapest cost to produce hydrogen, general transportation access, general land characteristics, and proximity to NEER renewable projects (without a PPA). The tool quickly displays the best options for further scrutiny, using recommendations from an algorithm and layers displayed in a UI. The overall goal is to have a high-level algorithm that can generally push developers toward the best land to lock up for wind+solar+electrolyzer options on leases.

The algorithm considers the overall cost and feasibility of building a co-located green hydrogen site (wind+solar+electrolyzer) by clustering together land parcels that can produce enough green hydrogen to fully power an electrolyzer of five different capacities on an annual basis for different eFuels (green hydrogen, green ammonia, synthetic natural gas). It scores the input costs (renewable capital costs, transmission capital costs, water capital costs, net “grid revenue” that accounts for excess energy sales and shortfall energy costs, and CO2 costs), transport access (to pipelines, pipeline right-of-ways, highways, and railroads), land characteristics, and proximity to NEER renewables projects. Overall, the algorithm will favor land parcel clusters with higher NCFs, complimentary wind resources/solar resources, lower wholesale electricity prices (LMPs), contiguous buildable land, fewer land owners, transport access, and proximity to NEER renewables.

### Overall Assumptions

The algorithm for example clusters together land parcels with enough land to power an electrolyzer of 5 different capacities (100 MW, 200 MW, 300 MW, 500 MW, 1 GW) on an annual basis. The electrolyzer is assumed to have a 95% capacity factor and “runs” for the cheapest 95% of hours as determined by the mean LMP modified by the net grid usage/production and a price scalar (for example $D per percent of grid electricity usage, relative to electrolyzer capacity). How the green hydrogen site will change LMPs if it is using electricity from the grid or selling excess renewable generation to the grid, is considered using a linear model. Excluded are any land parcels deemed unbuildable and cluster the best parcels based on minimizing the renewable capital costs (when deciding between overlapping parcels).

### Algorithm Design

Users can specify the fuel they want and the choice of five canned electrolyzer sizes that can influence the Land Score and the Input Cost Score. The overall score is a weighted mean of the categories, with fatal flaw score weighting that increases the weights of very low scores (e.g., if an area is not viable due to poor transmission or water access, then it consumes the overall score).

### Filtering Examples:

Land Parcel size: Parcels that are at least 30 acres
Distance to transmission: Within 25 miles of a ≥115 kV substation or within 25 miles of a ≥115 kV transmission line
USGS protected areas
Government-owned property
Existing solar farms from EIA
Parcels within a 3-mile buffer of existing wind turbines (from American Wind Energy Association (AWEA)) or recent FAA turbine filings (within the last 5 years)
Parcels with too little renewable production as a percent of the electrolyzer usage (<0.1% of net annual usage)

### Other Assumption Examples

Standard energy density for wind (60 acres per MW) and solar (12 acres per MW)
Maximum number of installed renewables allowed is 4× the capacity of the electrolyzer
Installed wind-to-solar ratio is a square root of (wind_ncf/solar_ncf)
   Algorithm also tries to make the wind-to-solar ratio just be the max possible on each parcel, which typically will favor more solar than wind in land-constrained areas. This is to allow the algorithm to build more solar in areas where not enough buildable land exists for wind (usually due to small parcel size and related setbacks).
Day-ahead LMPs (multiplied by 2) are used as a proxy for retail rates for times when the electrolyzer uses energy from the grid (based on hourly NCFs from a typical year, scaled to average year), increased by $D for every percent shortfall compared to electrolyzer capacity. Day-ahead LMPs are assumed to be the base price for energy sold to the grid, reduced by $D for every percent excess compared to electrolyzer capacity. In this way, how the green hydrogen site will change LMPs if it is using electricity from the grid or selling excess renewable generation to the grid, using a linear model is being simulated.
Electrolyzer capacity factor is 95%
Project lifetime is 20 years
Discount rate is 7% (used for adding the electricity costs to all capital costs, which get divided by project lifetime with no NPV accounting)

### Clustering

Adjacent land parcels are clustered together from a land owner and calculate all capital costs (renewables, transmission) and net electricity costs. After doing so, the algorithm will cluster together different landowners together to find the cheapest way to power the electrolyzer with renewables. It will do this using two different assumptions on allocating wind vs. solar capacity and removing any relatively expensive overlaps.
For the five different electrolyzer sizes, land parcels are clustered together so that they can entirely power the electrolyzer with renewables (based on its capacity factor, 95%). For each parcel with high renewable production, the algorithm will cluster together parcels within a county by searching over increasing radii to try to reach the load of the electrolyzer. For a given search radius, if the algorithm gathers enough renewable production from nearby land parcels to serve the load, it will choose the other parcels in order of capital cost per MW (trimming off any excess capacity and capital costs from the highest-cost parcels). Before it goes to a larger search radius, it will see if there are any overlapping clusters and sequentially eliminate higher-cost clusters. The algorithm will keep trying to make clusters until it reaches its maximum search radius (for example 5 km for a 100 MW electrolyzer, 23 km for a 1 GW electrolyzer). Remaining unclustered parcels may remain if there are no large parcels to cluster together, or parcels are too scattered to be combined into a reasonably compact cluster of parcels.
   Only parcels with enough renewable production to serve 0.5% of the electrolyzer load are considered, so this essentially eliminates very small parcels for 100 MW electrolyzers (parcels with less than about 10 acres of wind-buildable land) or fairly large parcels for a 1 GW electrolyzer (parcels with less than about 80 acres of wind buildable land)
After the cheapest clusters of land parcels are identified from a capital cost perspective, the algorithm will determine the total electricity cost by calculating shortfall electricity costs (with price inflation for times that the electrolyzer pulls more from the grid) and excess renewable revenue (with price suppression for high renewable production periods). These costs are converted to NPV and are added to the capital costs. These are calculated for each cluster and not each land parcel because the wind/solar capacities that power the electrolyzer may not be known until clusters are made.

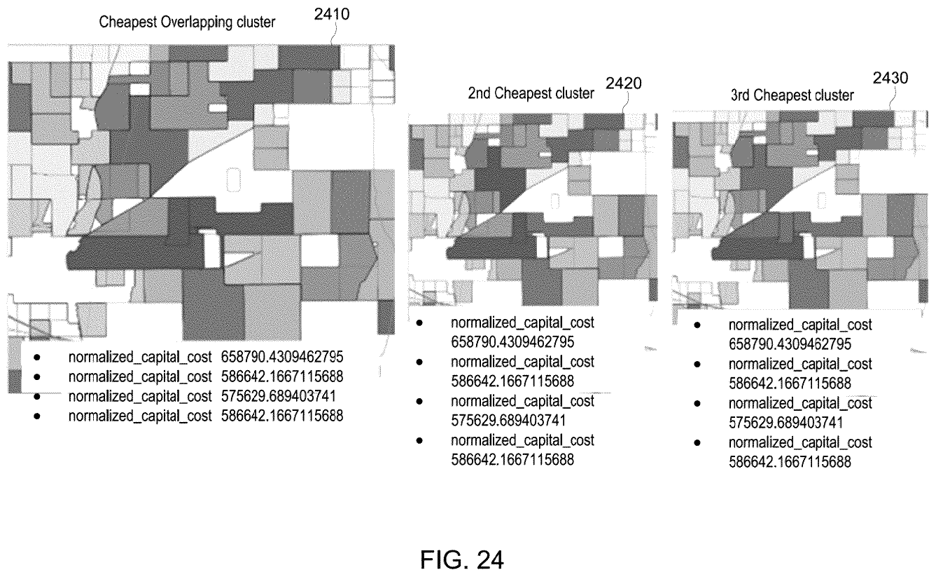

FIG. 24 illustrates an example of three clustering outputs of the H2Viewer tool with the least expensive overlapping cluster on the left, the second least expensive overlapping cluster in the middle, and the third least expensive overlapping cluster on the right.

### Input Cost Score

The Input Cost Score describes the cost to produce green hydrogen for a given size electrolyzer based on renewable characteristics, wholesale electricity prices, transmission costs, water costs, and other input costs (like CO2 for synthetic natural gas)
Electricity: Calculate the cost of electricity based on LMPs+capital cost for substation/gen-tie connection/solar/wind on-site, convert to score
   Total Electricity cost=Electricity capital cost (expressed as NPV with 7% discount rate)+Electricity Usage Cost (energy from grid*LMP*2)
   Electricity capital cost (per year)=(gen tie cost+substation facility costs+solar capital costs (capital cost per mw*max solar capacity)+wind capital cost (capital cost per mw*max wind capacity))/renewable lifetime
      Solar and wind capital costs are based on the size of each contiguous chunk of buildable land in a parcel, with a fixed cost per buildable chunk+variable cost per MW, with the largest buildable chunks chosen first until the installed wind/solar capacity is reached.
   Electricity cost (calculated for each cluster): Total grid cost=NPV (shortfall energy costs-excess energy revenue)
      Shortfall energy costs
         Calculate the grid electricity price, which is the LMP*2+$D*percent_shortfall_energy, where percent_shortfall_energy is the percent of the electrolyzer that is powered by the grid.
         In this way, how the green hydrogen site will change LMPs if it is using electricity from the grid or selling excess renewable generation to the grid is simulated, using a linear model.
         Remove the 5% most expensive times of the year (if electrolyzer capacity factor is 95%) based on the price
   Total grid electricity cost=sum (grid_electricity_price $ grid_electricity_usage)
   Excess energy revenue
      Calculate the renewable sale price, which is the LMP-$D*percent_excess energy, where percent_excess_energy is the percent renewable generation in excess of the electrolyzer capacity
      Total excess energy revenue=sum (renewable_sale_price*renewable_energy_sales_to_grid)
Water cost: Simple model that represents the cost of tapping into an existing public water well/reservoir, making a new well in an aquifer, or making a new well outside of an aquifer
CO2 cost: Capital cost for connecting to an available CO2 source (like an ethanol plant without CO2 sourcing rights secured by another entity, and the cost of a new CO2 pipeline ($2 MM/mile that increases incrementally with distance)

### Transport Score

Score based on the distance to pipelines (hydrogen, ammonia, oil/gas as proxy), distance to an interstate highway, and distance to rail (if applicable)
   Scores are calculated using logistic/linear/exponential curves that mimic the desired behavior (e.g., scores get much worse as distance to highway increases)

### NEE Prospect Score

Score based on the density of existing and planned renewable prospects in the area from Omni

### Land Score

Weighted score based on different metrics of land feasibility like the number of land owners, availability of land owner/land use information, tree coverage, presence of oil rigs in a parcel

### Overall Score

Weighted average of individual score categories, with fatal flaw scoring for some score categories (escalating weights for very low scores to replicate the fatal flaw aspect of some categories)

### Planning

### Additional Features

Additional fuel types (green ammonia, synthetic natural gas)
   Ammonia
      Rail costs in transport score
   Synthetic natural gas
      Proximity to CO2 pipelines/producers (ethanol plants, landfills?) for input costs
      Natural gas transmission pipeline distance for Transport Score
Flexible weights in the UI
   Allows users to modify the weights for the different categories in the UI
Account for potential demand charges/utility willingness to allow a large industrial load to connect to the grid
   Simplest possible: Get utility service area and score based on size

### Filtering

Land Parcels that are unviable based on a number of criteria are filtered out.
Land Parcel size: Parcels that are at least 30 acres
Distance to transmission: Within 25 miles of a ≥115 kV substation or within 25 miles of a ≥115 kV transmission line
USGS protected areas
Government-owned property
Existing solar farms from EIA
Parcels within a 3-mile buffer of existing wind turbines (from AWEA) or recent FAA turbine filings (within the last 5 years)
Parcels with too little renewable production as a percent of the electrolyzer usage (<0.1% of net annual usage)

### Electrolyzer/Input Costs

The Electrolyzer/Input Cost Score is a measure of the cost for the inputs to an Electrolyzer and other equipment (for green ammonia or SNG). Normalized cost information will be calculated and stored, with the scores based on the total cost for a standard electrolyzer size.

For the Input Cost Score, there are at least two approaches that can potentially identify the best land parcels based on minimizing input costs.

### Input Cost Calculation

Calculate the cost for every variable and express it as a 0-100 score, passing costs into the final output
   Electricity: Total Renewable Capital Cost (divided evenly over 20 years)+Total Transmission Capital Cost (divided evenly over 20 years)+Net Electricity Costs (converted to NPV)
      Electricity capital cost (per year)=(gen tie cost+substation facility costs+solar capital cost (see below)+wind capital cost (see below))/renewable lifetime
         Total wind and solar capacity built for each land parcel is allocated based on the wind/solar NCFs and capital costs and capped based on the voltage of the nearest 5 substations within 20 miles. Mandating a fixed ratio of wind/solar capacity within each parcel pushes the algorithm to generally favor lower-cost combinations of wind and solar when parcels are clustered together to serve an electrolyzer load.
         Wind/solar ratio: (NCF_{wind}/CapEx_{wind})/(NCFₛₒₗₐᵣ/CapExₛₒₗₐᵣ)
         Total wind and solar capacity are scaled down
         Renewable capital costs are calculated for each contiguous chunk of buildable land within a land parcel using a variable cost model
         Solar
         Base Cost for each “plant” within a parcel=$3 MM per chunk of contiguous solar BLL
         Cost Scalar=$1.125 MM per MW
         Total Cost=Base Cost+Cost Scalar*buildable_chunk_mw
         Capped at the maximum cost per MW of 2 MW ($2.625 MM/MW)
         Wind
         Base Cost for each “plant” within a parcel=$500K per chunk of contiguous wind BLL
         Cost Scalar=$1 MM per MW
         Total Cost=Base Cost+Cost Scalar*buildable_chunk_mw
         Capped at the maximum cost per MW of 2 MW ($1.25 MM/MW).
      Note that the fixed cost for solar is set to be higher for wind, which in effect, drives a much higher penalty for less continuity of buildable land for solar than for wind. This is meant to include the fact that wind turbines are inherently more dispersed than solar (e.g., the wind doesn't explicitly use all of the buildable land like solar), resulting in less of a steep rise in costs per MW for wind than for solar. (capital cost assumptions have since changed since this plot, but the shape of these graphs is generally the same)

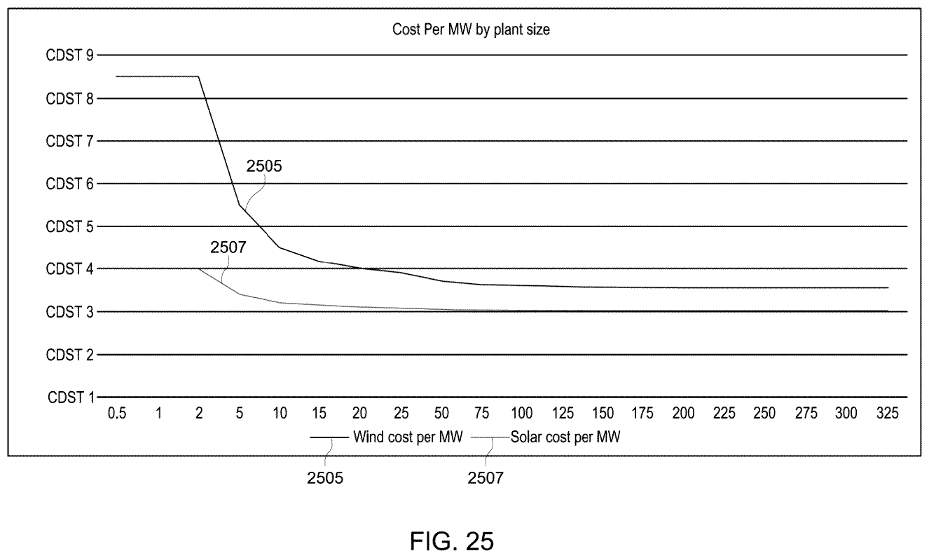

FIG. 25 is an example graph of wind cost per MW 2505 and solar cost per MW 2507 based on plant size.
Overall effect
   When doing the capital cost calculations using a variable cost model for each contiguous chunk of buildable land instead of just a fixed cost per MW for the entire parcel, parcels that bad smaller average contiguous chunks of buildable land (solar and wind) have higher costs. Parcels with very large contiguous chunks of buildable land have no significant change in electricity costs (in $/kg H2).

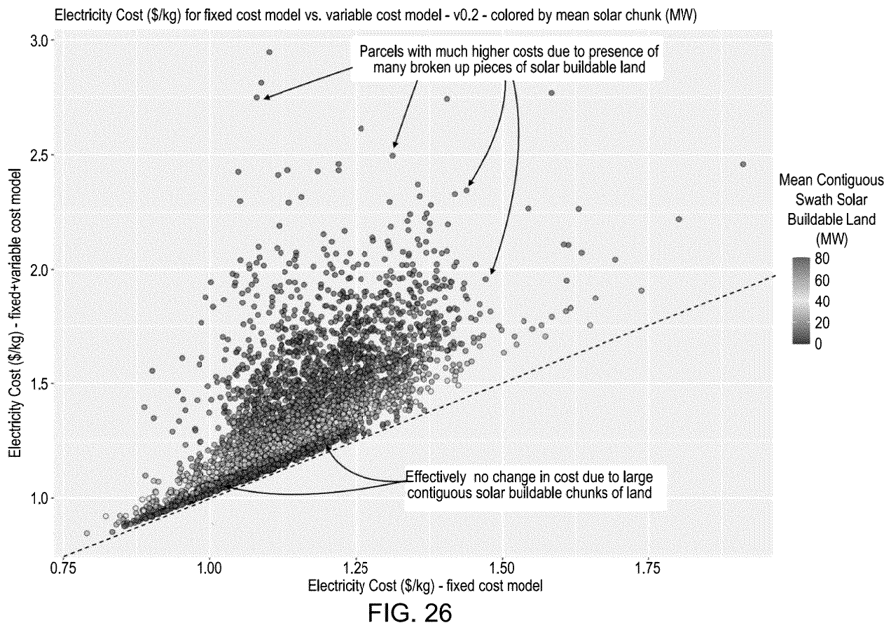

FIG. 26 is an example graph of electricity cost for fixed costs versus variable costs for solar.

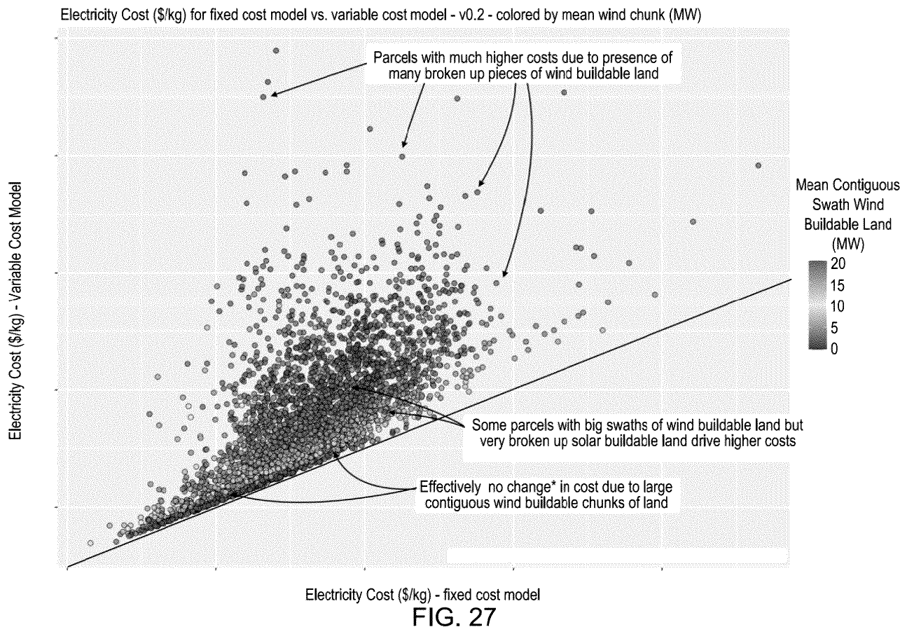

FIG. 27 is an example graph of electricity cost for fixed costs versus variable costs for wind.
Electricity cost (calculated for each cluster): Total grid cost=NPV (shortfall energy costs-excess energy revenue)
   Shortfall energy costs
      Calculate the grid electricity price, which is the LMP*2+$D*percent_shortfall_energy, where percent_shortfall_energy is the percent of the electrolyzer that is powered by the grid
      Remove the 5% most expensive times of the year (if electrolyzer capacity factor is 95%) based on the price
   Total grid electricity cost=sum (grid_electricity_price*grid_electricity_usage)
      Excess energy revenue.
         Calculate the renewable sale price, which is the LMP-$D*percent_excess_energy, where percent_excess_energy is the percent renewable generation in excess of the electrolyzer capacity
         Total excess energy revenue=sum (renewable_sale_price*renewable_energy_sales_to_grid)
   Water: Score based on the density of wells in location, distance to underground water tanks, distance to surface water
      A high price for new wells and pipelines to off-site wells may be given to express the uncertainty of new water sources/permitting, etc., to force the algorithm to nudge toward existing water sources
      CO₂: Scored based on the distance to the closest available biogenic CO2 source (ethanol plants, etc.)

### Input Cost Score Calculation

Input costs are linearly translated to a 0-100 score distribution between the minimum total cost and the 99th percentile of total input costs (electricity+water). In that way, the lowest cost cluster of parcels has a score of 100, while every parcel cluster with a cost greater ≥99th percentile of the total cost has a score of 0.

### Input Cost Data

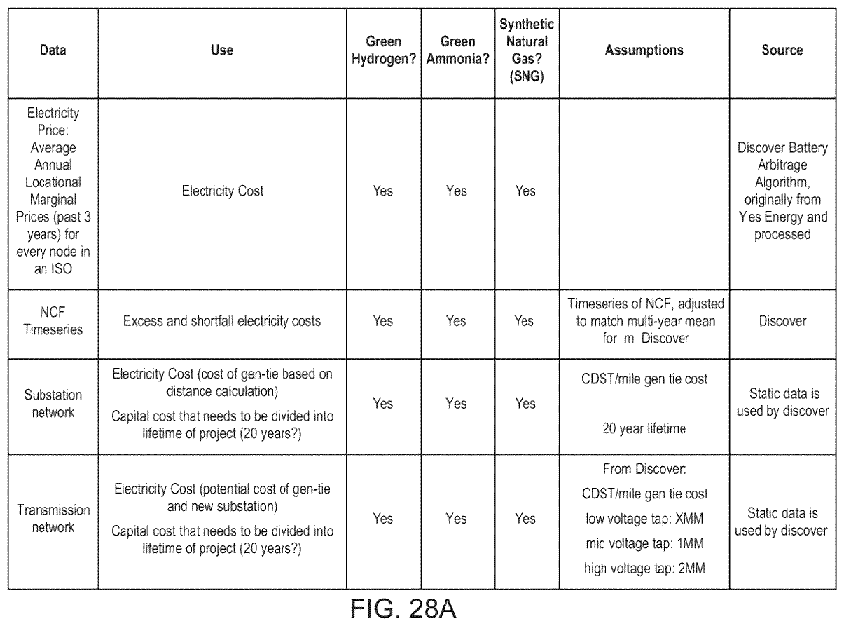

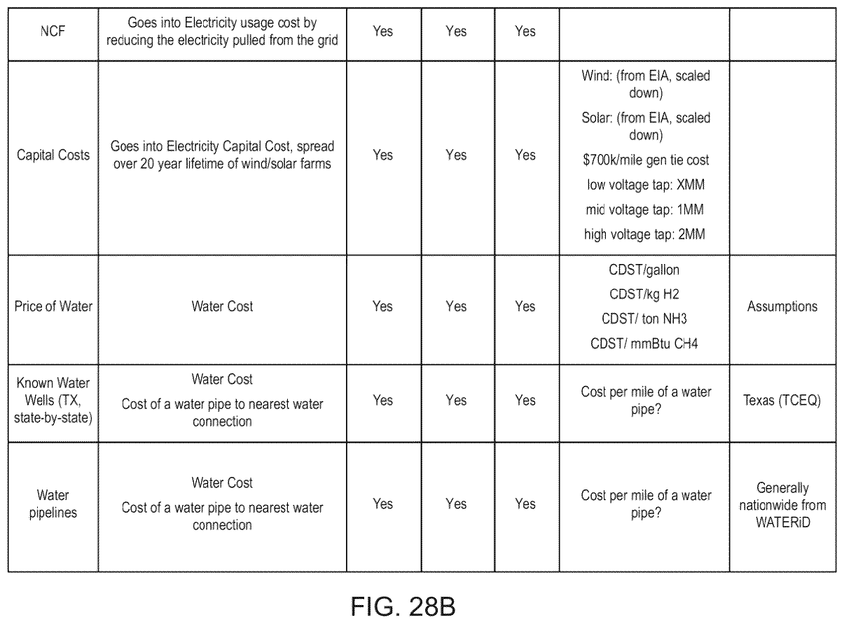

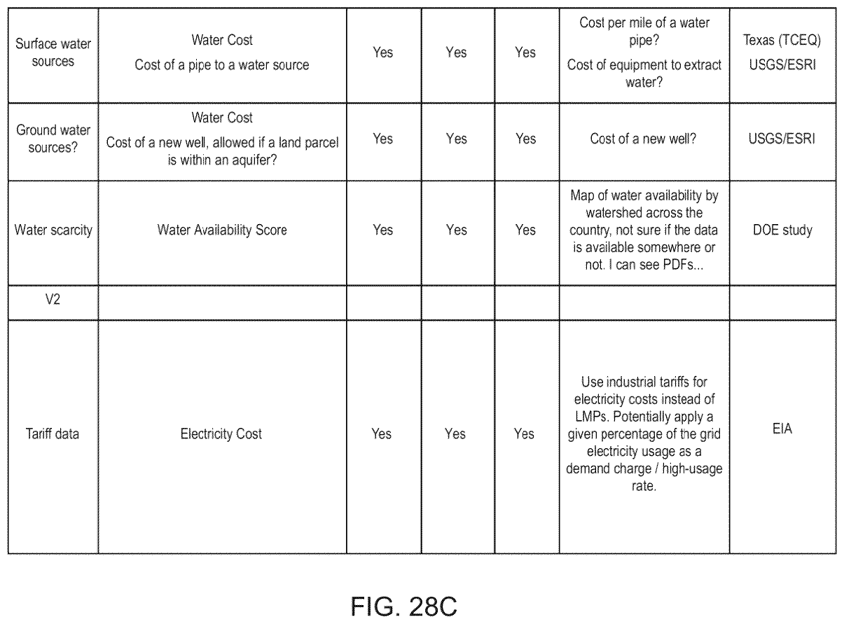

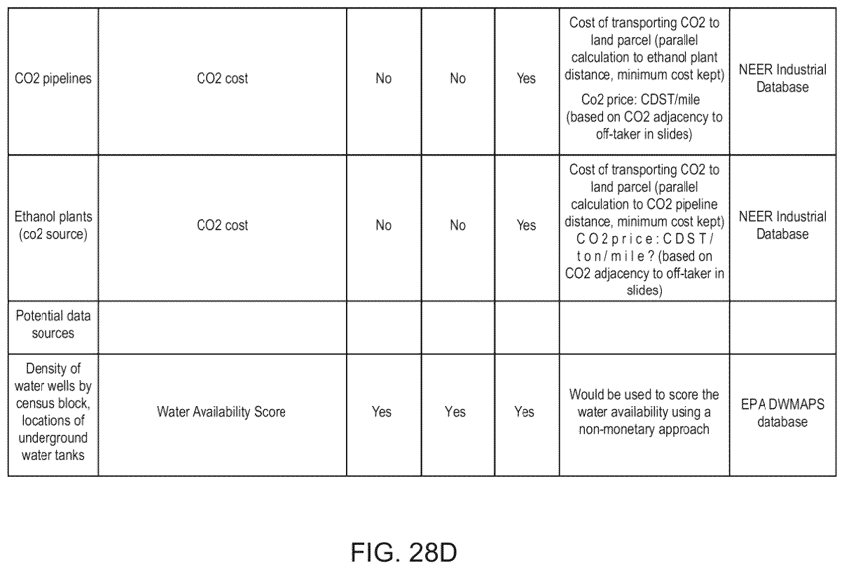

See FIG. 28A thru FIG. 28D for a table of input cost data.

### Transport Score

The Transport Score (expressed as a dimensionless 0-100) represents the connectivity of the site to transport products to customers via pipeline (gaseous transport using existing hydrogen pipeline or existing oil/gas pipeline right of ways) or highway (for liquid hydrogen), with the weight primarily on the transport of gaseous hydrogen via pipeline (80%).

### Implementation Version 1

Transport Score=0.80*Pipeline Score+0.20*Road Score
Pipeline Score (80% of weight)
   The Pipeline Score for a parcel is the maximum score of any of the pipelines below (oil, natural gas, hydrogen, or ammonia)
   Oil and Natural Gas Pipeline right of ways
      The goal is to score the proximity to existing large transmission-level oil and natural gas pipelines. Those can more easily support the construction of a new hydrogen pipeline due to existing right of way and lower incremental opposition (for an additional pipeline vs. an entirely new pipeline right of way). The algorithm filters oil and gas pipelines to only consider transmission pipelines with a large diameter (>24 cm for gas pipelines and >12 cm for oil pipelines). The algorithm ignores the much more prevalent feeder pipelines. These smaller-diameter feeder pipelines are designed for local distribution rather than regional transmission.
      Here the score is based on the distance to an oil or gas pipeline, with an exponential decay function that decreases the score by half for every 5 miles of additional distance between a parcel and a pipeline.

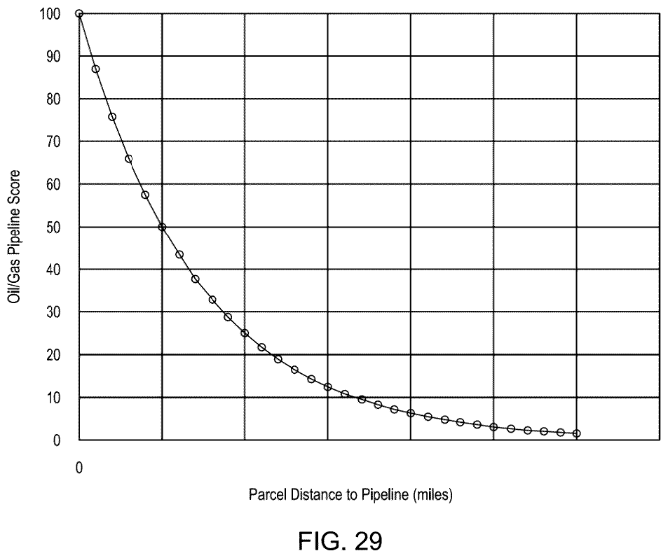

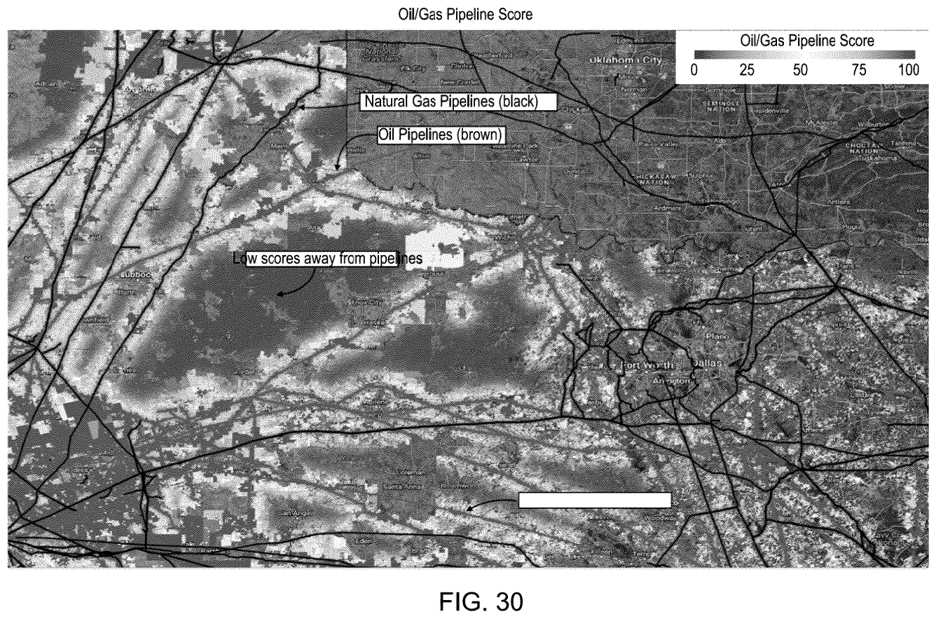

FIG. 30A and FIG. 30B is an illustration of a map with the oil/gas pipeline score applied with abandoned ammonia pipelines included, such as those of FIG. 29, to identify a combination of parcels of land with the highest score or ranking.
Existing hydrogen or ammonia pipelines
   Score based on the linear distance to the closest hydrogen or ammonia pipeline, with a linear conversion of distance to score. Parcels that intersect a hydrogen/ammonia pipeline have a score of 100, while pipelines that are much further away from a pipeline have a pipeline score of 0.
      Natural gas pipelines will be incorporated into the pipeline score for synthetic natural gas
   Method
      Hydrogen pipeline: 100—distance_to_pipeline/zero_score_distance_to_pipeline
      Ammonia pipeline: 100—distance_to_pipeline/zero_score_distance_to_pipeline
      All the above parameters can be changed in the efuels config file within “scores”→transport_score”→“pipeline”→‘hydrogen’/‘ammonia’→‘distance_zero_score_miles’
   Example (including the now-defunct Magellan ammonia pipeline) of transport score before and after the pipeline score was added

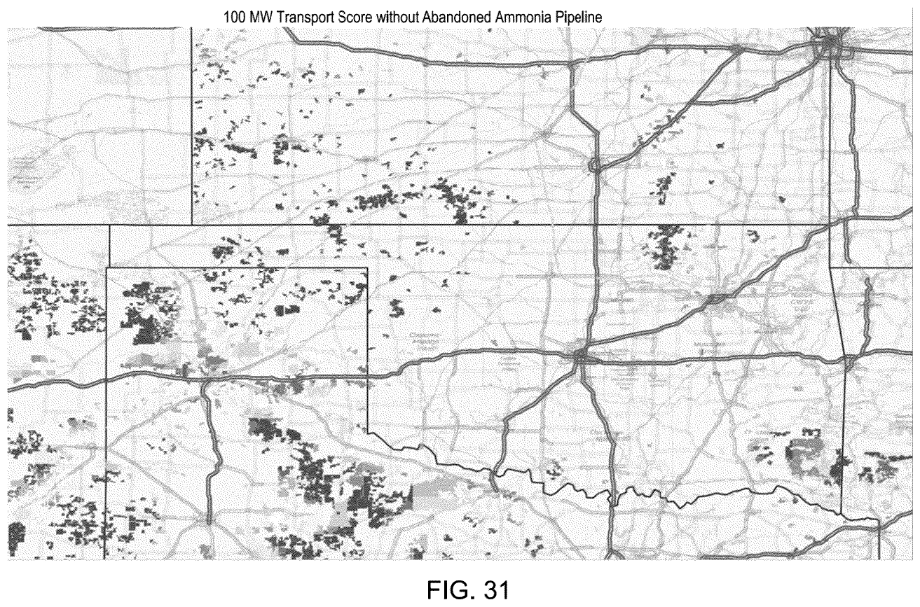

FIG. 31 is an illustration of a map with the 100 MW transport score applied without the abandoned ammonia pipeline included to identify a combination of parcels of land with the highest score or ranking.

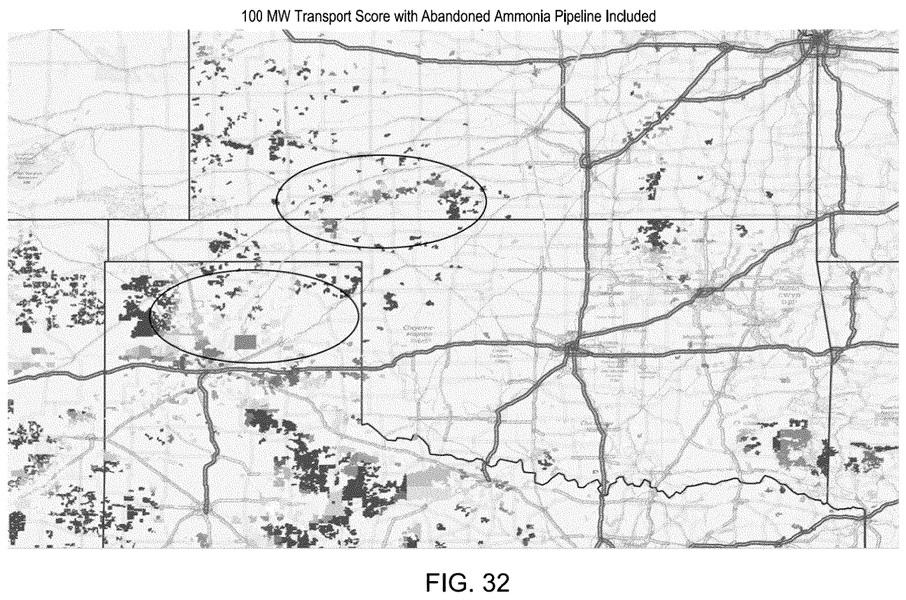

FIG. 32 is an illustration of a map with the 100 MW transport score applied with the abandoned ammonia pipeline included to identify a combination of parcels of land with the highest score or ranking.
Road Score (20%)
   Score based on the distance to the highway, with a linear penalty based on the distance to the closest interstate highway (depending on the path) and the distance to the closest highway (assuming suboptimal transport to that highway from the parcel).
   The goal is to give a lower score for land parcels that are farther from interstate highways, with less of a penalty for parcels that are close to major non-interstate highways (contiguous paths of 4+lane highways that are connected to interstates). All of it is based on linear distances but should help push recommendations toward areas with better access to interstates or major highways connected to interstates.

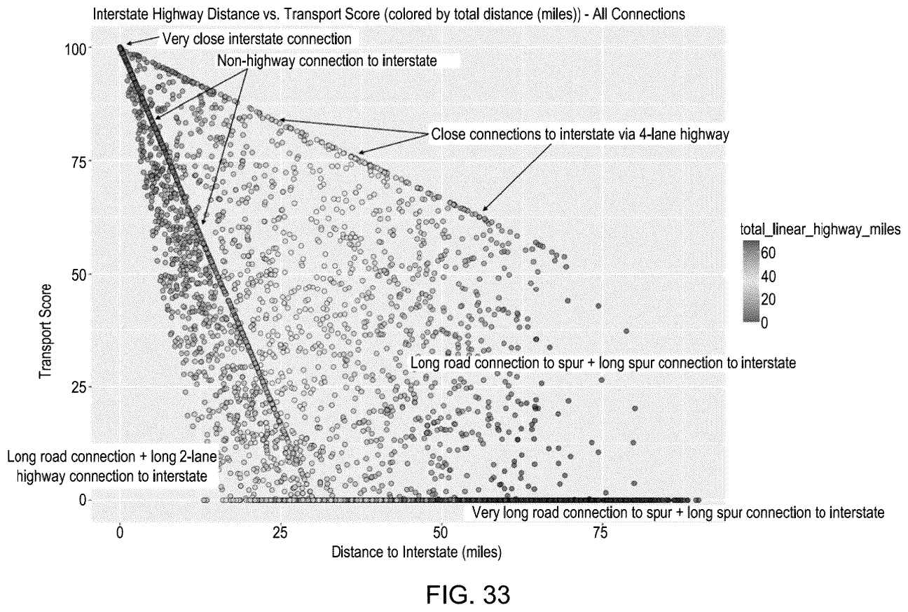

FIG. 33 is an illustration of an interstate highway distance versus transportation score using color emphasis by distance.

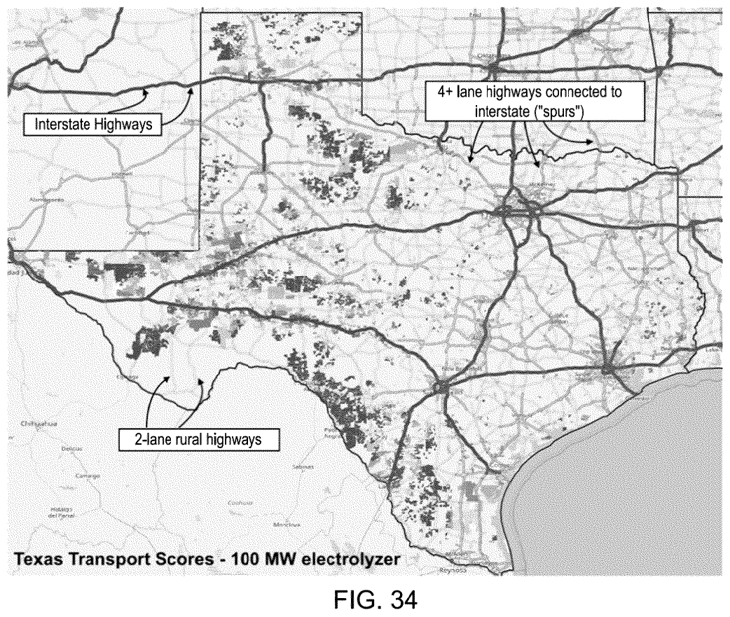

FIG. 34 is an illustration of a map with Texas transport scores applied using 100 MW electrolyzer, to identify a combination of parcels of land with the highest score or ranking.
Method
   Parcels where the closest highway is an interstate highway
      Transport Score=100−distance_to_interstate/zero_score_distance
         zero_score_distance=X miles
   Parcels where the closest highway is a 4+lane divided highway that is connected to an interstate highway (“spur” highway)
   Transport Score=100-distance_to_interstate
      zero_score_distance_spur_to_interstate-distance_to_spur_highway/zero_score_distance_to_highway
      zero_score_distance_spur_to_interstate=Y miles
      zero_score_distance_to_highway=Z miles
   All the above parameters can be changed in the efuels config file within “scores”→“transport_score”→‘road_score’→“interstate_closest”/“spur_highway_closest”

### Advanced Version

Perform routing to all customers within a reasonable distance and score based on the “ease” of connecting to customers. This could involve a merge of the market score with the transport score, which may need to happen for examples having synthetic natural gas, and the “customers” will be accessed by connecting to a pipeline.

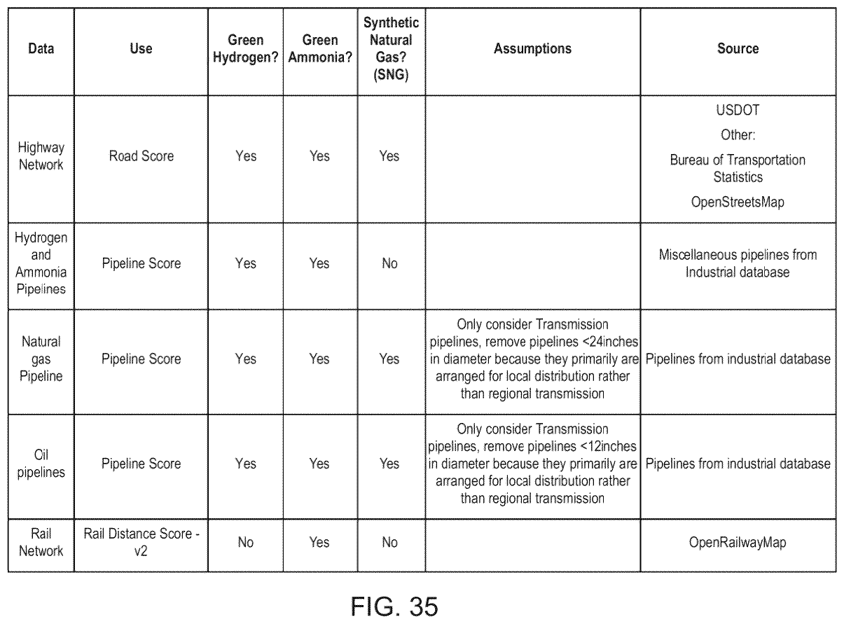

See a table of various green hydrogen transmission routing categories in FIG. 35.

### NEE Prospect Score

The NEE Prospect Score (expressed as a dimensionless 0-100 score) quantifies how easily a cluster can potentially access an advanced project (operational merchant or prospect in advanced development) for a vPPA. It is based on the proximity to operating merchant NEE wind/solar/storage projects as well as active Omni prospects without a PPA. Scores are based on the size of the NEE project (relative to the electrolyzer capacity) as well as the distance between a cluster and a project. NEE Prospect Scores are summed across all technologies to highlight clusters that may have any nearby vPPA opportunity.
NEE Prospect Score=NEE Prospect Score_{wind}+NEE Prospect Scoreₛₒₗₐᵣ NEE Prospect Score_{wind}, considering the 3 closest prospects per technology and sum up all cluster-prospect pairs for all technologies.
NEE Prospect Score_{cluster, prospect}=100*(Prospect_MW*0.5^{(prospect_distance_miles/half_distance_miles)})/(4*electrolyzer_capacity), where half_distance_miles=25

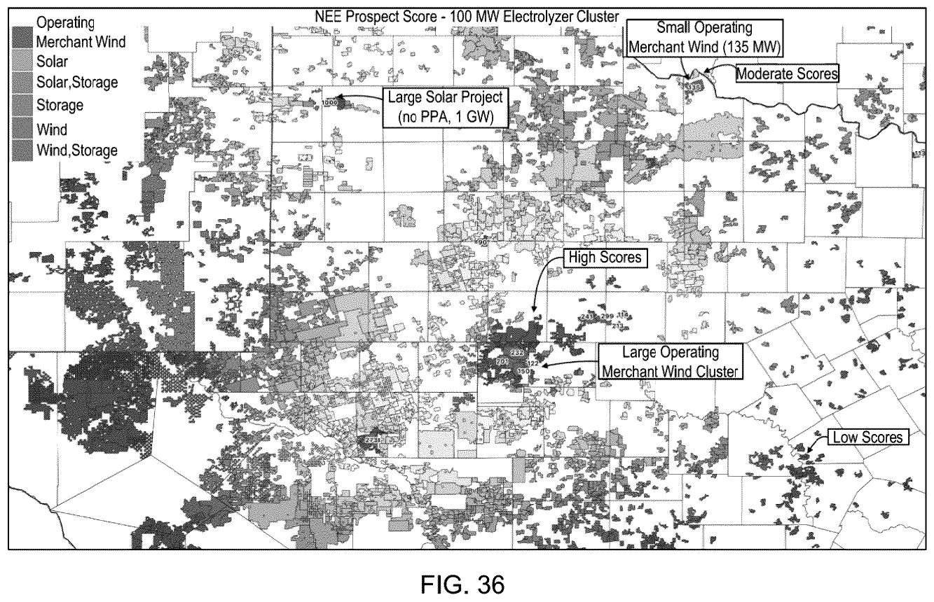

FIG. 36 is an example of clustering parcels of land to provide a prospect score for 100 MW electrolyzer.

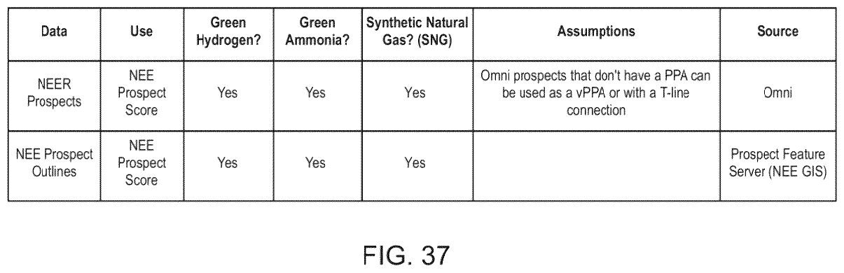

FIG. 37 is a table of various simplified considerations for prospects.

### Alternate Versions

Moderate version:
   Score based on the density of existing, planned, and potential (Discover clusters) NEER renewable prospects
   Add in the negative impact of contracted projects (i.e., projects with a PPA signed), as a new co-located electrolyzer could negatively impact another NEER project
Advanced version:
   Allow choice of a specific renewable prospect from Omni and price out the cost of using that prospect, score it

### Land Score

A score that ranks/adjusts the scores based on the overall feasibility of building a co-located electrolyzer on a site, given general characteristics about the land, ownership information, categorical land use information, and NORAD radar proximity. It accounts for aspects of the land which are beyond technical buildability, addresses parcels that may require much more work/time/cost to build, or may run into internal/external obstacles to becoming operational. The approach is to generally score land attributes like contiguous buildable area and the number of land owners to make a cluster, as well as some targeted penalties for other undesirable characteristics that reduce the operational probability.

### Simple Version:

Weighted mean of Land Owner Count Score and Buildable Land Score, with penalties applied for parcels that have missing/bad land owners, missing/bad land use types, proximity to NORAD radars (based on wind saturation level), and density of oil wells.
   Weighted mean
      Land Owner Count Score (50% weight)
         A simple exponential decay curve that decreases by 50% for every 4 owners (clusters with 1 land owner have a score of 100). This pushes recommendations more towards single land owner clusters (once cluster multiple owners are clustered together).
      Buildable Land Score (50% weight)
         Weighted average of wind_buildable_land_score and solar_buildable_land_score, each of which are exponential decay curves. This pushes recommendations towards parcels with more contiguous buildable land.
         Score=100−(100*decay_factor*mean_buildable_chunk_mw)
         decay_factor_{wind}=0.7 (Score >95 for a mean buildable chunk of ˜8 MW)
         decay_factorₛₒₗₐᵣ=0.95 (Score >95 for a mean buildable chunk of ˜50 MW).
      Note that this is also accounted for in the input cost scoring where higher capital costs for farms with more broken up buildable land are produced. It is also here to provide an indication that the land within the parcel cluster is low quality, as well as further reduces the scores for sites with poor land characteristics.
   Penalties are applied to the Land Score for the following factors to help steer developers away from parcels that may be technically buildable but are less feasible/harder to build due to factors being targeting here. They are applied by multiplying the land score (from above weighed averages) by the penalty factor:
      Missing and/or bad land owners, as specified in the config (scores→land_score→penalties→bad_land_owner). This is to represent how some parcels with missing land owners are often conglomerations of all the missing data in a county/area, or they require more effort to search. (Sometimes a single parcel's appearance is erroneous or “mirage”). Some are also owners that are very likely government owned and were not filtered out with land owner codes (“GV”). If there are other land owners that are universally infeasible, they can be easily added to the config.
      Missing and/or bad land uses, as specified in the config (scores→land_score→penalties→bad_land_use). This is to represent the uncertainty that comes with not knowing the land use or if some large tough-to-build land uses are present like cemeteries, exempt property, parks (many are removed with protected areas), country clubs, drinking water reservoirs, public right of ways, government ownership.
      Proximity to NORAD radars. NORAD radars are assessed by how saturated they are for wind (a higher saturation of wind turbines near a NORAD radar can add another obstacle to building wind), and a penalty that decreases with distance from a NORAD radar and is more severe for more “saturated” radars may be applied.

### Advanced Version:

Calculate the cost of removing buildings on site and preparing unbuildable land.
Oil/gas well density. The areas around oil wells are technically buildable, but many oil wells in a parcel can often kill a solar project (cited by hydrogen developers and many solar fatal flaws in Discover). This could be added, but for now, the well density is somewhat correlated with the mean buildable solar chunk and the electricity cost, the pricing capital costs may be accounted for by the size of contiguous buildable land chunks.
Building footprints: a score based on the footprints of buildings within land parcels. This becomes more important if modeling stand-alone electrolyzers that may be sited near factories/industrial areas. The buildable land generally takes care of this now.

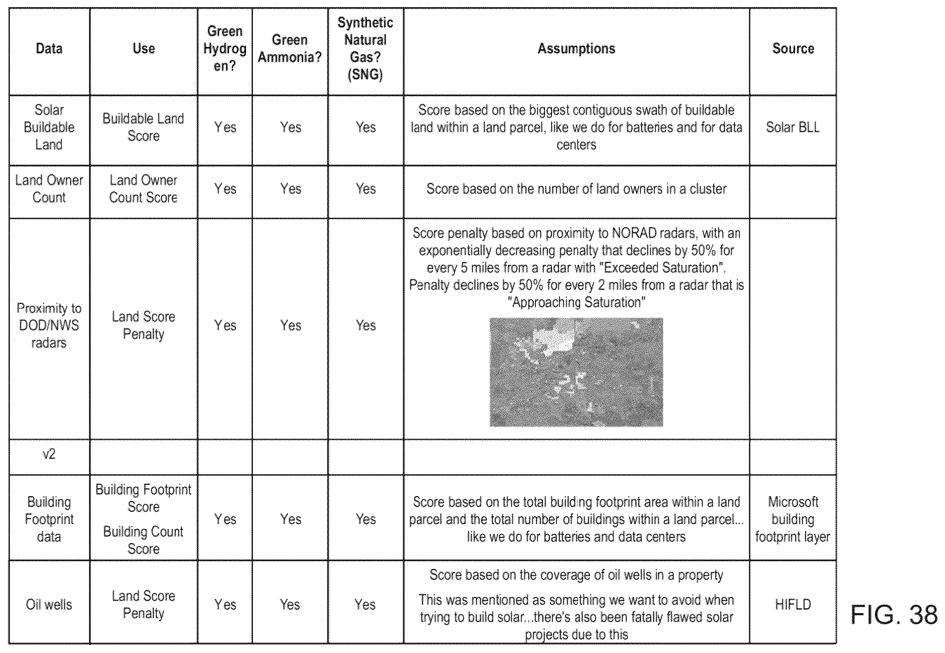

FIG. 38 is a table of various more advanced considerations for prospects.

### Overall Score

The Overall Score uses a conditional weighted average (with higher weights for some very high or very low scores) that gets linearly stretched to a 0-100 range. This is meant to give more influence in some situations where a category may not typically be that influential, except in some cases where very low or very high scores have disproportionate impacts on the viability of a cluster.

### Starting Weights Example

Input Cost Score: 60%
Transport Score: 20%
Land Score: 10%
NEE Prospect Score: 10%
   Conditional weights (flexible weights) Example
Some categories are given higher weights for clusters that have very high or very low scores in particular categories to give 1) a disproportionate penalty for a very bad score in a category that can act like a fatal flaw (e.g., very poor land characteristics, very poor transportation connectivity) or 2) disproportionate bonus for a very good score in a particular category (very high Customer or NEE Prospect Scores). In those cases, weights are linearly scaled up from their starting weight until their max weight, and other scores have their weights scaled down evenly.
Penalty Conditions
   Meant to give a large nudge away from prospects that have significant fatal flaws besides input costs (which are already weighted the highest)
   Land Score weights are higher whenever the Land Score is lower than 20, with a maximum weight of 50%
Bonus Conditions
   Meant to give a small nudge to areas with very high customer density or very close merchant/non-PPA NEE Prospects with high capacities. The “bonus nudge” is relatively smaller than penalties to still give a lot of weight to highly impactful factors like the input costs.

The algorithm will tell the UI to ingest specific files by listing them in a JSON JavaScript object syntax.

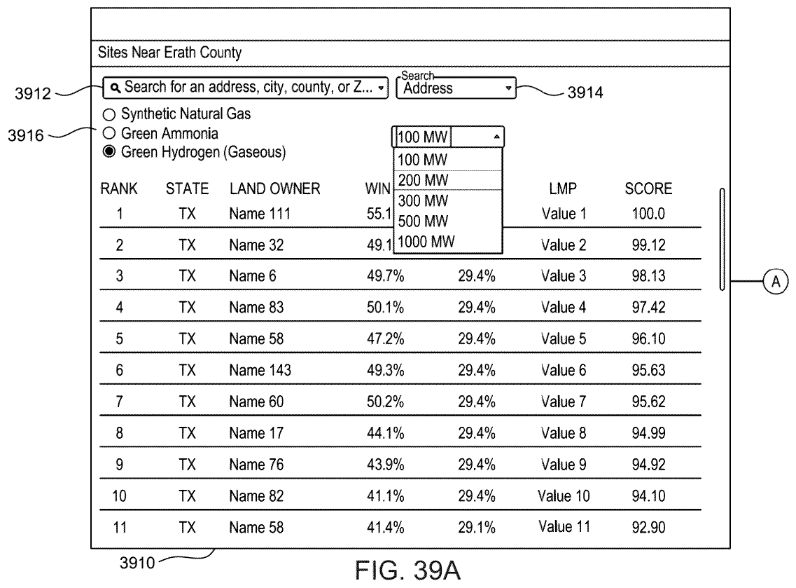

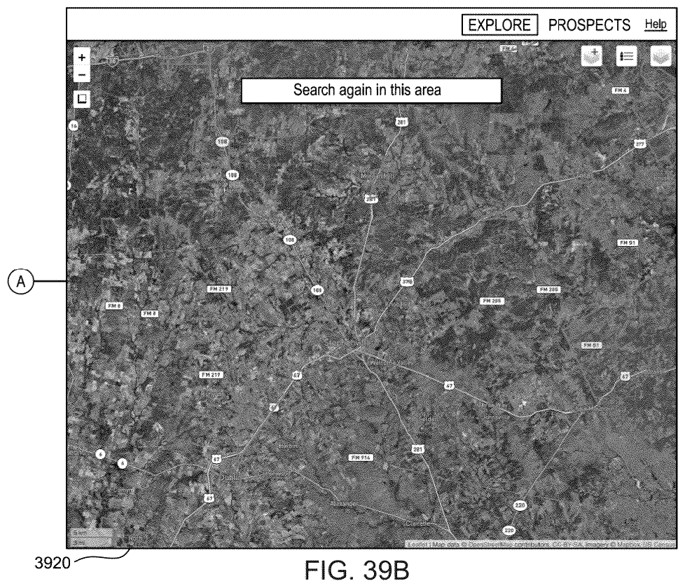

FIG. 39 is an illustration of a map with a ranking of landowners for a 100 MW Green Hydrogen project to identify a combination of parcels of land with the highest score or ranking

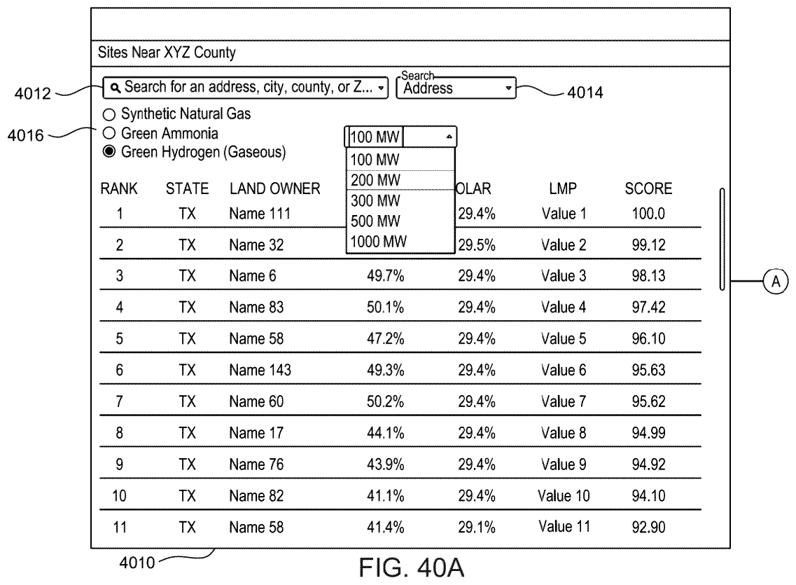

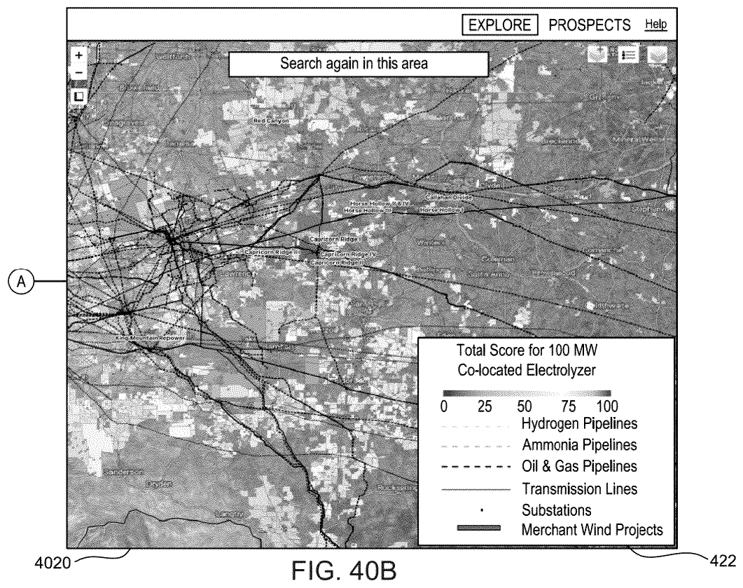

FIG. 40A and FIG. 40B is a map with a ranking of landowners for a 100 MW Green Hydrogen project to identify a combination of parcels of land with the highest score or ranking, along with displaying hydrogen pipelines, ammonia pipelines, oil & gas pipelines, transmission lists, substations, and wind projects.

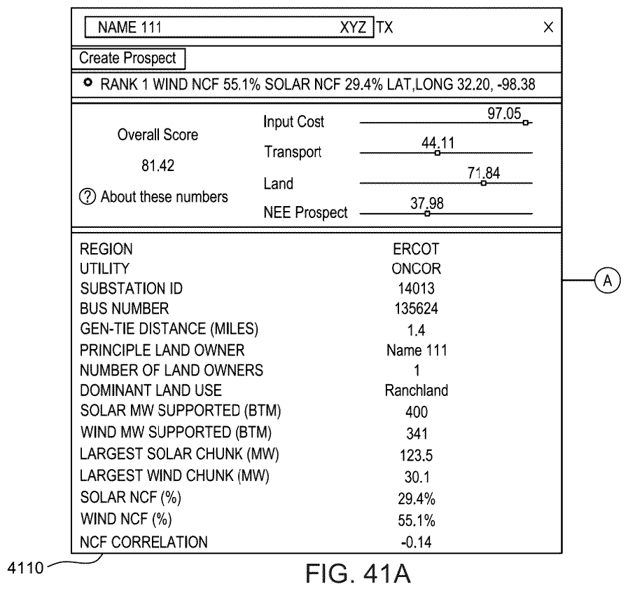

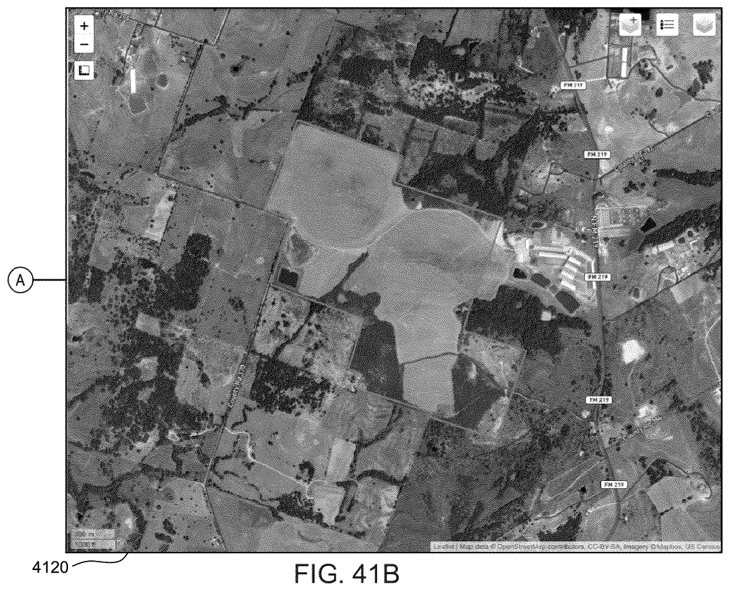

Display score information after a cluster is selected by the user. See FIG. 41 is a map with score information after a user selection of Name 111 in FIG. 40.

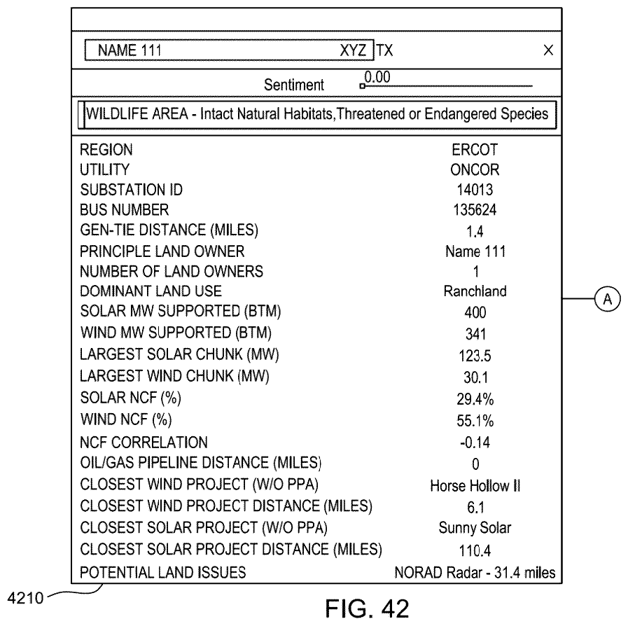

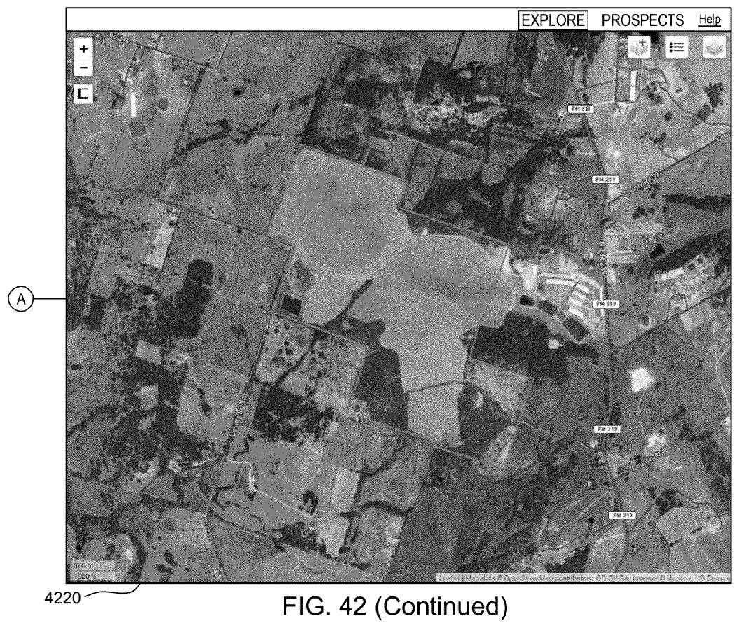

Display land parcel information after a cluster is selected by the user. See FIG. 42A and FIG. 42B is a map with cluster information after a user selection of the cluster in FIG. 41A and FIG. 41B.

### List of Variables:

### Additional Scoring Methods

Customer Score (formerly Market Score)

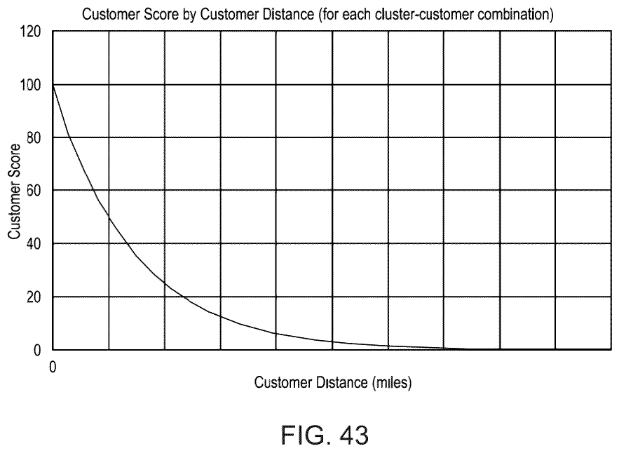

The Customer Score (expressed as a 0-100 score) is calculated based on the local/regional customer density for selling the fuel to relevant customers. This may be done by getting the sum of all customer scores for the five closest customers for a given fuel. The customer score for each cluster-customer combination is calculated using an exponential decay function that decreases for example by half for every 20 miles of distance (a customer 20 miles from a cluster gets assigned a cluster-customer score of 50). Customer Scores from all five cluster-customer combinations are summed up for each cluster of land parcels, producing the Customer Score. This simple function is meant to give a score bonus to the cluster of land parcels that are very close to a single customer (one ammonia plant within X miles) or somewhat close to many different customers (e.g., five refineries that are about 10× miles away). This may not be desirable due to the desire to currently prospect for a discrete number of delivery points along the Gulf Coast and the fact that trying to site plants for individual customers (e.g., refinery or ammonia plant) has issues around cost competitiveness. However, making this more of a general customer density score with less influence from individual customers may be desirable. FIG. 43 is a graph of customer scores by customer distance.

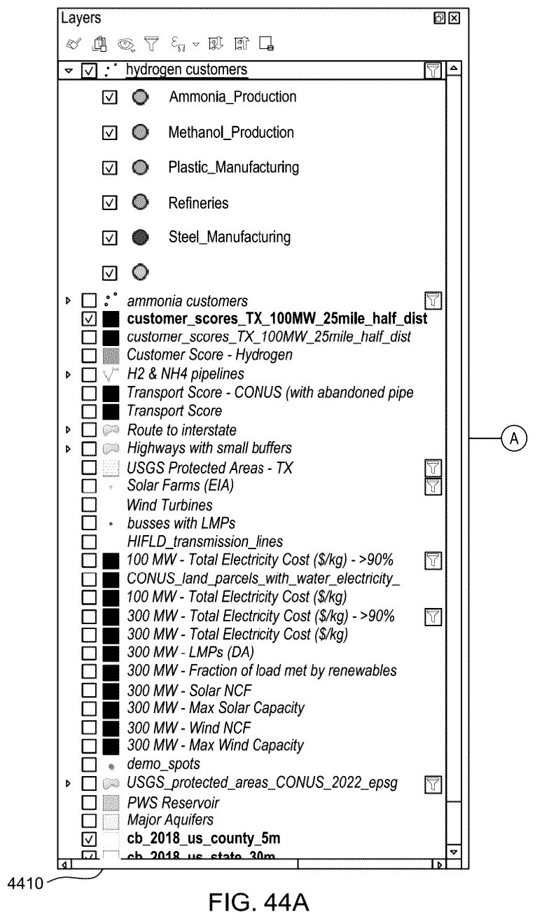

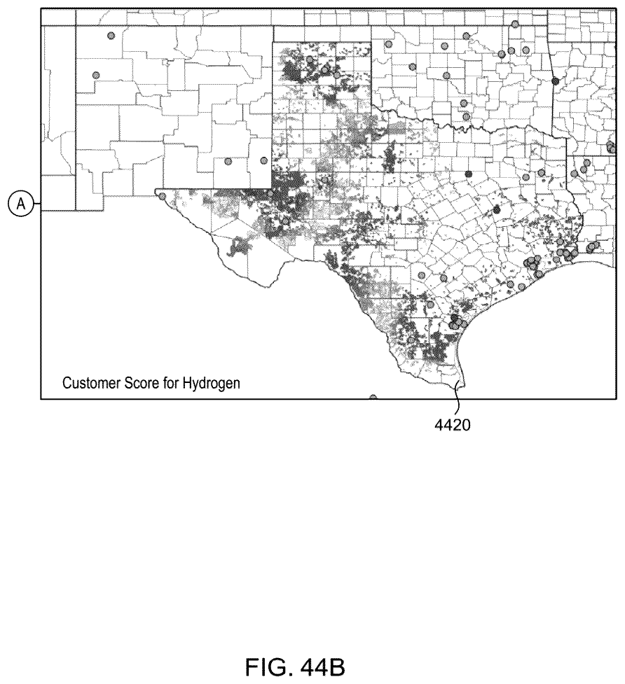

FIG. 44 illustrates a map with a layering of information based on user selection for hydrogen.

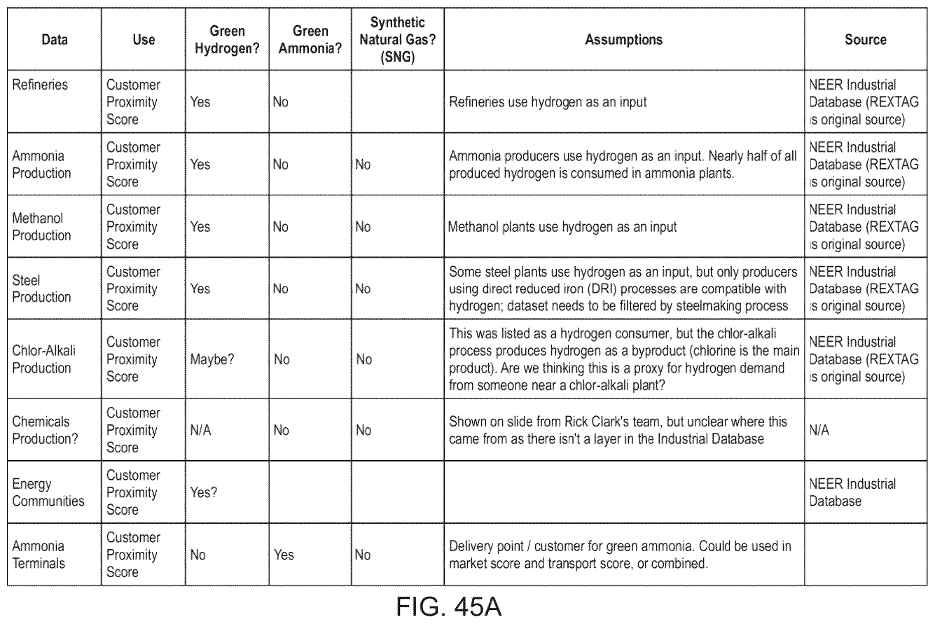

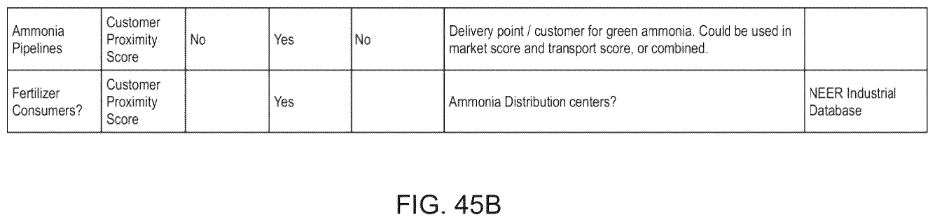

FIG. 45A and FIG. 45B are a table of data used for maps.

### Additional Features

Live connection to an internal database of refineries and other industrial facilities
Medium complexity version
   Allow the users to specify the customer type in the UI
Advanced Version.
   Allow the user to specify a specific customer and have the algorithm calculate a score based on the distance to that customer

### Flow of Identifying Land Parcels for Hydrogen, Synthetic Natural Gas or Ammonia Production

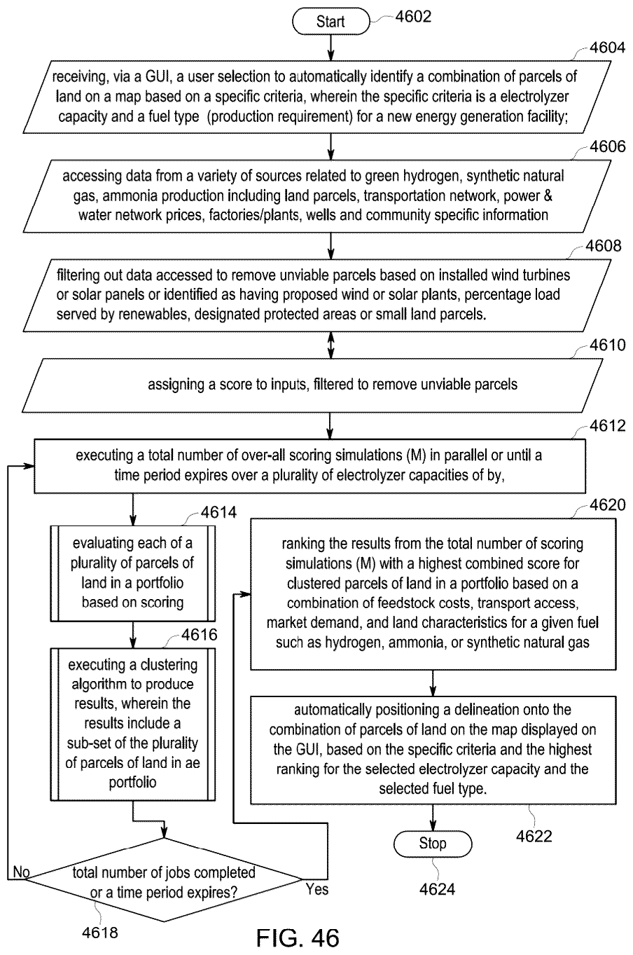

FIG. 46 is a flow method for identifying parcels of land to construct a green hydrogen, synthetic natural gas, or ammonia production facility. The process begins in step 4602 and immediately proceeds to step 4604, where the system receives, via a GUI, a user selection to automatically identify a combination of parcels of land on a map based on a specific criteria, wherein the specific criteria is a electrolyzer capacity and a fuel type i.e. a production requirement for a new energy generation facility. See FIG. 21 and an example GUI is shown in FIG. 39, and FIG. 40. The process proceed to step 4606

In step 4606, a plurality of projections is performed. The projections begin with accessing data from a variety of sources related to green hydrogen, synthetic, and ammonia production, including land parcels, transportation networks, power & water network prices, factories/plants, wells, and community-specific information, such as local tax incentives and willingness to participate in a specific hydrogen, synthetic natural gas, or ammonia production facility project. The process continues to step 4606. The process continues to step 4608.

In step 4608, the data that has been converted into a uniform format is filtered. The filtering includes removing unviable parcels based on installed wind turbines or solar panels or identified as having proposed wind or solar plants, percentage load served by renewables, designated protected areas, or small land parcels. The process continues to step 4610.

In step 4610, a score is assigned to each of the inputs filtered to remove unviable parcels. The process continues to step 4612.

In another example, the criteria of transmission characteristics for each parcel of land in the portfolio may include the size of substation hardware costs, network upgrade costs, or grid tie-in costs. The process continues to step 4608.

In step 4610, the process begins a loop in which a total number of simulations (M) are executed in parallel up to the total number of jobs or until a time period expires by steps 4612 and step 4614.

In step 4614, by evaluating each of the plurality of parcels of land based on scoring. Next, in step 4616, a clustering algorithm is executed to produce results, wherein the results include a subset of the plurality of parcels of land in the portfolio. The process continues to step 4618. If the number of simulations is complete or time period expires, the process continues to step 4620. Otherwise, the process returns to step 4610.

In step 4620, the results are ranked from the total number of scoring simulations (M) with the highest combined score for clustered parcels of land in the portfolio based on a combination of feedstock costs, transport access, market demand, and land characteristics for a given fuel such as hydrogen, ammonia, or synthetic natural gas. The process continues to step 4622.

In step 4622, the system automatically positions a delineation onto the combination of parcels of land on the map displayed on the GUI, based on the specific criteria and the highest ranking for the selected electrolyzer capacity and the selected fuel type. Examples of this delineations are shown in FIG. 34, FIG. 36 and FIG. 39 through FIG. 40, and FIG. 45. The process ends in step 4624.

### Information Processing System

The present subject matter can be realized in hardware, software, or a combination of hardware and software. A system can be realized in a centralized fashion in one computer system or in a distributed fashion where different elements are spread across several interconnected computer systems. Any kind of computer system- or other apparatus adapted for carrying out the methods described herein-is suitable. A typical combination of hardware and software could be a general-purpose computer system with a computer program that, when being loaded and executed, controls the computer system such that it carries out the methods described herein.

The present subject matter can also be embedded in a computer program product, which comprises all the features enabling the implementation of the methods described herein, and which-when loaded in a computer system-is able to carry out these methods. Computer program in the present context means any expression, in any language, code, or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information. In general, the computer readable medium embodies a computer program product as a computer readable storage medium that embodies computer readable program code with instructions to control a machine to perform the above-described methods and realize the above-described systems.

### General Computer for Implementing Algorithm

The present invention can be implemented on a standalone computer system, a server, a web-server, a cloud computing system or a hybrid cloud system, or other on-demand availability of computer system resources, especially data storage and computing power, without direct active management by the user.

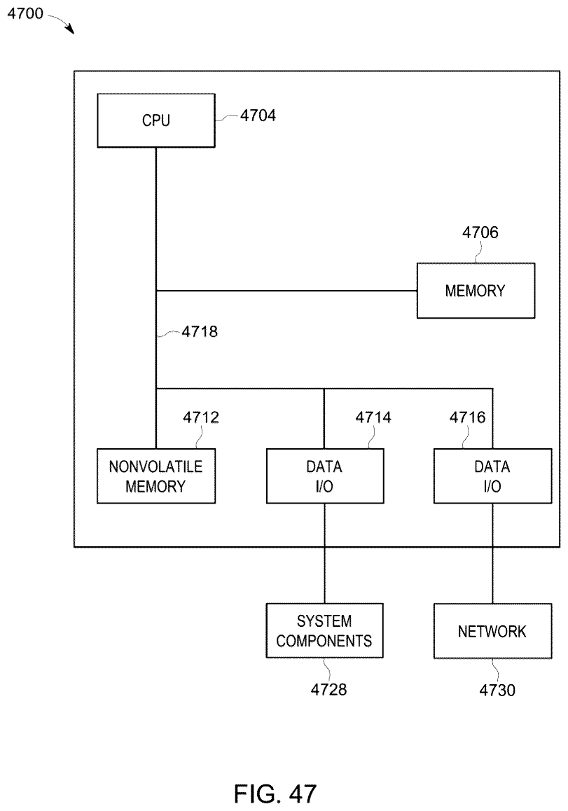

FIG. 47 illustrates a block diagram illustrating a processing system 4700 for carrying out a portion of the present invention, according to an example. The processor system 4700 is an example of a processing subsystem that is able to perform any of the above-described processing operations, other operations, or combinations of these, such as the flow diagram of FIG. 46.

The processor 4700 in this example includes a hardware processor or CPU 4704 that is communicatively connected to a main memory 4706 (e.g., volatile memory), a non-volatile memory 4712 to support processing machine instruction and operations. The CPU is further communicatively coupled to a network adapter hardware 4716 to support input and output communications with external computing systems such as through the illustrated network 4730.

The processor 4700 further includes a data input/output (I/O) processor 4714 that is able to be adapted to communicate with any type of equipment, such as the illustrated system components 4728. The data input/output (I/O) processor, in various examples, is able to be configured to support any type of data communications connections, including present-day analog and/or digital techniques or via a future communications mechanism. A system bus 4718 interconnects these system components.

### Non-Limiting Examples

Although specific embodiments of the subject matter have been disclosed, those having ordinary skill in the art will understand that changes are made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A computer-implemented method for positioning a delineation over a combination of parcels of land on a graphical user interface (GUI) of a computer system, that identifies parcels of land to construct a renewable energy fuel facility as one of a green hydrogen fuel facility, a synthetic natural gas fuel facility or an ammonia production fuel facility to reduce greenhouse gas emissions, the method comprising:
receiving, via a GUI, a user selection to automatically identify a combination of parcels of land on a map based on a specific criteria, wherein the specific criteria is an electrolyzer capacity and a fuel type for a new energy generation facility;
performing a plurality of project projections by:
accessing a data from a variety of sources related to the fuel type, including one or more of land parcels, transportation networks, power and water network prices, factories/plants, wells and community-specific information, or a combination thereof;
filtering out data accessed to remove unviable parcels of land based on one or more of installed wind turbines or solar panels, proposed wind or solar plants, a percentage load served by renewables, designated protected areas, small land parcels, or a combination thereof;
assigning a score to inputs that have been filtered to remove unviable parcels
executing a total number of simulations (M) simultaneously in parallel, over each of a plurality of electrolyzer capacities by,
evaluating each of a plurality of parcels of land in a portfolio based on scoring; and
executing a clustering algorithm to produce results, wherein the results include a subset of the plurality of parcels of land in the portfolio;
ranking the results from the total number of scoring simulations (M) with a highest combined score for clustered parcels of land in the portfolio based on a combination of input costs, transport access, market demand, and land characteristics for the fuel type; and
automatically positioning a delineation onto the combination of parcels of land on the map displayed on the GUI, based on the specific criteria and the highest ranking for the selected electrolyzer capacity and the selected fuel type.

2. The computer-implemented method of claim 1, wherein the executing the total number of simulations (M) are executed in parallel up to a total number of jobs or until a time period expires.

3. The computer-implemented method of claim 2, wherein the total number of simulations, the time period, or both are settable by a user.

4. The computer-implemented method of claim 1, wherein for each parcel of land in the portfolio, the at least one land characteristic includes one or more of size of the parcel, ownership of the parcel, tree coverage in the parcel, elevation of the parcel, terrain of the parcel, buildable land area of the parcel, location of the parcel to nearby renewable projects, or a land owner's determined willingness to sell rights to the parcel.

5. The computer-implemented method of claim 4, wherein for each parcel of land in the portfolio, the at least one land characteristic includes tree clearing costs of each parcel.

6. The computer-implemented method of claim 1, wherein the ranking the results from the total number of scoring simulations (M) with the highest combined score for clustered parcels of land in the portfolio based on a combination of input costs, transport access, market demand, and land characteristics for the fuel type, and further includes
input costs based on expected locational marginal price (LMP) for a settable frequency with year based on electricity prices, simulated wind/solar production, and an impact on local electric grid prices in response to the new energy generation facility constructed as a green hydrogen fuel facility.

7. The computer-implemented method of claim 1, wherein the ranking the results from the total number of scoring simulations (M) with the highest combined score for clustered parcels of land in the portfolio based on a combination of input costs, transport access, market demand, and land characteristics for the fuel type, and further includes
input costs based on estimated cost of purchasing energy from a local electric grid for a settable frequency and selling excess renewable energy to the local grid during the settable frequency for the new energy generation facility constructed as a green hydrogen fuel facility at every location using settable frequency of estimated wind production, estimated solar production, and market prices.

8. The computer-implemented method of claim 1, wherein the ranking the results from the total number of scoring simulations (M) with the highest combined score for clustered parcels of land in the portfolio based on a combination of input costs, transport access, market demand, and land characteristics for the fuel type, and further includes
input costs based on a local communities willingness to participate in the new energy generation facility constructed as a green hydrogen fuel facility.

9. The computer-implemented method of claim 1, wherein the ranking the results from the total number of scoring simulations (M) with the highest combined score for clustered parcels of land in the portfolio based on a combination of input costs, transport access, market demand, and land characteristics for the fuel type, and further includes input costs based on a tax incentives to participate in the new energy generation facility constructed as a green hydrogen fuel facility.

10. A system for positioning a delineation over a combination of parcels of land on a graphical user interface (GUI) of a computer system, that identifies parcels of land to construct a renewable energy fuel facility as one of a green hydrogen fuel facility, a synthetic natural gas fuel facility or an ammonia production fuel facility to reduce greenhouse gas emissions, the system comprising:
a computer memory capable of storing machine instructions; and
a hardware processor in communication with the computer memory, the hardware processor configured to access the computer memory to execute the machine instructions for
receiving, via a GUI, a user selection to automatically identify a combination of parcels of land on a map based on a specific criteria, wherein the specific criteria is an electrolyzer capacity and a fuel type for a new energy generation facility;
performing a plurality of project projections by:
accessing a data from a variety of sources related to the fuel type, including one or more of land parcels, transportation networks, power and water network prices, factories/plants, wells and community-specific information, or a combination thereof;
filtering out data accessed to remove unviable parcels of land based on one or more of installed wind turbines or solar panels, proposed wind or solar plants, a percentage load served by renewables, designated protected areas, small land parcels, or a combination thereof;
assigning a score to inputs that have been filtered to remove unviable parcels
executing a total number of simulations (M) simultaneously in parallel, over each of a plurality of electrolyzer capacities by,
evaluating each of a plurality of parcels of land in a portfolio based on scoring; and
executing a clustering algorithm to produce results, wherein the results include a subset of the plurality of parcels of land in the portfolio;
ranking the results from the total number of scoring simulations (M) with a highest combined score for clustered parcels of land in the portfolio based on a combination of input costs, transport access, market demand, and land characteristics for the fuel type; and
automatically positioning a delineation onto the combination of parcels of land on the map displayed on the GUI, based on the specific criteria and the highest ranking for the selected electrolyzer capacity and the selected fuel type.

11. The system of claim 10, wherein the executing the total number of simulations (M) are executed in parallel up to a total number of jobs or until a time period expires.

12. The system of claim 11, wherein the total number of simulations, the time period, or both are settable by a user.

13. The system of 10, wherein for each parcel of land in the portfolio, the at least one land characteristic includes one or more of size of the parcel, ownership of the parcel, tree coverage in the parcel, elevation of the parcel, terrain of the parcel, buildable land area of the parcel, location of the parcel to nearby renewable projects, or a land owner's determined willingness to sell rights to the parcel.

14. The system of claim 13, wherein for each parcel of land in the portfolio, the at least one land characteristic includes tree clearing costs of each parcel.

15. The system of claim 10, wherein the ranking the results from the total number of scoring simulations (M) with the highest combined score for clustered parcels of land in the portfolio based on a combination of input costs, transport access, market demand, and land characteristics for the fuel type, and further includes
input costs based on expected locational marginal price (LMP) for a settable frequency with year based on electricity prices, simulated wind/solar production, and an impact on local electric grid prices in response to the new energy generation facility constructed as a green hydrogen fuel facility.

16. The system of claim 10, wherein the ranking the results from the total number of scoring simulations (M) with the highest combined score for clustered parcels of land in the portfolio based on a combination of input costs, transport access, market demand, and land characteristics for the fuel type, and further includes
input costs based on estimated cost of purchasing energy from a local electric grid for a settable frequency and selling excess renewable energy to the local grid during the settable frequency for the new energy generation facility constructed as a green hydrogen fuel facility at every location using settable frequency of estimated wind production, estimated solar production, and market prices.

17. The system of claim 10, wherein the ranking the results from the total number of scoring simulations (M) with the highest combined score for clustered parcels of land in the portfolio based on a combination of input costs, transport access, market demand, and land characteristics for the fuel type, and further includes
input costs based on a local communities willingness to participate in the new energy generation facility constructed as a green hydrogen fuel facility.

18. The system of claim 10, wherein the ranking the results from the total number of scoring simulations (M) with the highest combined score for clustered parcels of land in the portfolio based on a combination of input costs, transport access, market demand, and land characteristics for the fuel type, and further includes
input costs based on a tax incentives to participate in the new energy generation facility constructed as a green hydrogen fuel facility.
